(19) United States
(12) Patent Application Publication
(10) Pub. No.: US 2026/0363296 A1
(43) Pub. Date: Nov. 19, 2026

(54) ELASTIC FLEECE FOR ORAL PRODUCTS

(71) Applicant: NICOVENTURES TRADING LIMITED, London (GB)

(72) Inventors: Yu YAO, London (GB); Benjamin JENKINS, London (GB); Rosa GALATI, London (GB); Arian FEJZULLA, London (GB)

(21) Appl. No.: 19/709,967

(22) Filed: Jun. 16, 2026

Related U.S. Application Data
(63) Continuation of application No. PCT/IB2024/062913, filed on Dec. 19, 2024.

(30) Foreign Application Priority Data
Dec. 20, 2023 (GB) 2319617.3

(51) Int. Cl. A24B 15/30; A24B 15/24; A24B 15/28

(52) U.S. Cl. CPC A24B 15/303; A24B 15/243; A24B 15/283

(57) ABSTRACT

The disclosure of this application provides elastic fleece materials and oral product comprising such elastic fleece materials, which can exhibit modified release of components from within the oral product to a user's oral cavity. Such fleece materials can include, e.g., elastic or elastomeric material-containing fibers.

### CROSS-REFERENCE TO RELATED APPLICATION

The present application is a continuation of International Patent Application No. PCT/IB2024/062913, filed Dec. 19, 2024, which claims priority to patent application GB2319617.3, filed Dec. 20, 2023. The disclosures of each of these applications are incorporated herein by reference in their entireties.

### FIELD OF THE DISCLOSURE

The present disclosure relates to oral products intended for human use. The products are configured for oral use and deliver substances such as flavors and/or active ingredients during use. Such products may include tobacco or a product derived from tobacco, or may be tobacco-free alternatives.

### BACKGROUND

There are many categories of products intended for oral use and enjoyment. For example, oral tobacco products containing nicotine, which is known to have both stimulant and anxiolytic properties, have been available for many years. Conventional formats for so-called “smokeless” tobacco products include moist snuff, snus, and chewing tobacco, which are typically formed almost entirely of particulate, granular, or shredded tobacco, and which are either portioned by the user or presented to the user in individual portions, such as in single-use pouches or sachets. See for example, the types of smokeless tobacco formulations, ingredients, and processing methodologies set forth in U.S. Pat. No. 6,668,839 to Williams; U.S. Pat. No. 6,834,654 to Williams; U.S. Pat. No. 6,953,040 to Atchley et al.; U.S. Pat. No. 7,032,601 to Atchley et al.; and U.S. Pat. No. 7,694,686 to Atchley et al.; U.S. Pat. No. 7,810,507 to Dube et al.; U.S. Pat. No. 7,819,124 to Strickland et al.; U.S. Pat. No. 7,861,728 to Holton, Jr. et al.; U.S. Pat. No. 7,901,512 to Quinter et al.; U.S. Pat. No. 8,627,828 to Strickland et al.; U.S. Pat. No. 11,246,334 to Atchley, each of which is incorporated herein by reference.

In addition, traditional tobacco materials and non-tobacco materials have been combined with other ingredients to form product formats distinct from traditional smokeless products, with example formats including lozenges, pastilles, gels, and the like. See, for example, the types of products described in US Patent App. Pub. Nos. 2008/0196730 to Engstrom et al.; 2008/0305216 to Crawford et al.; 2009/0293889 to Kumar et al.; 2010/0291245 to Gao et al; 2011/0139164 to Mua et al.; 2012/0037175 to Cantrell et al.; 2012/0055494 to Hunt et al.; 2012/0138073 to Cantrell et al.; 2012/0138074 to Cantrell et al.; 2013/0074855 to Holton, Jr.; 2013/0074856 to Holton, Jr.; 2013/0152953 to Mua et al.; 2013/0274296 to Jackson et al.; 2015/0068545 to Moldoveanu et al.; 2015/0101627 to Marshall et al.; and 2015/0230515 to Lampe et al., each of which is incorporated herein by reference.

Oral pouched products are typically contained within a water-permeable fleece material formed from various types of fibers (e.g., cellulosic fibers or synthetic polymer fibers). For example, fleece materials may be provided in the form of a woven or nonwoven material. Example types of fleece materials, for example, are described in U.S. Pat. Nos. 8,931,493; 10,959,456; and U.S. Pat. No. 11,019,840 to Sebastian et al., which are all incorporated herein by reference. One challenge associated with certain fleece materials is the relatively long time period required for active ingredients and/or flavorants to diffuse through the fleece for the enjoyment of the user.

### BRIEF SUMMARY

According to the present disclosure, oral products (e.g., pouched oral products) comprising fleece materials having enhanced elasticity are provided. The enhanced elasticity is provided, in some embodiments, by selection or preparation of particular fiber types for inclusion within a fleece material used to enclose an oral composition. Such fleece materials can, in some embodiments, enhance diffusion of components within the pouched oral product to the user's oral cavity, as will be described herein in further detail. Accordingly, unique fleece compositions, as well as corresponding oral products and methods of preparing such fleece compositions and oral products, are provided herein.

The disclosure includes, without limitation, the following embodiments:

Embodiment 1: A pouched product, comprising: an outer water-permeable pouch defining a cavity and an oral composition comprising at least one water-soluble component within the cavity, wherein the outer water-permeable pouch comprises a fleece material comprising a plurality of fibers, and wherein at least a portion of the plurality of fibers comprise elastic or elastomeric fibers, the elastic or elastomeric fibers comprising one or more elastic or elastomeric materials.

Embodiment 2: The pouched product of Embodiment 1, wherein the outer water-permeable pouch comprises a single layer comprising the plurality of fibers.

Embodiment 3: The pouched product of Embodiment 1, wherein the outer water-permeable pouch comprises two or more layers, wherein at least one of the two or more layers comprises the elastic or elastomeric fibers.

Embodiment 4: The pouched product of any of Embodiments 1 to 3, wherein the elastic or elastomeric materials comprise one or more thermoplastic elastomers.

Embodiment 5: The pouched product of Embodiment 4, wherein the one or more thermoplastic elastomers are selected from the group consisting of styrenic elastomers, polyester elastomers, polyether elastomers, polysulfide elastomers, polyurethane elastomers, polyamide elastomers, polyolefin elastomers, thermoplastic vulcanizates, and copolymers, blends, and derivatives thereof.

Embodiment 6: The pouched product of Embodiment 5, wherein the one or more thermoplastic elastomers comprise a polyurethane elastomer.

Embodiment 7: The pouched product of any of Embodiment 4 to 6, wherein the thermoplastic elastomers are selected from polyisoprenes, butadiene rubber, styrene-butadiene rubber, poly(styrene-b-butadiene-b-styrene) (SBS), poly(styrene-b-ethene-co-butane-b-styrene (SEBS), poly(styrene-b-isoprene-b-styrene), ethylene propylene diene monomer rubber (EPDM rubber), EPDM rubber/polypropylene (EPDM/PP), polychloroprene, acrylonitrile-butadiene rubber, hydrogenated nitrile rubber, butyl rubber, ethylene-propylene rubber (EPM), silicone rubber, chlorosulfonated polyethylene, polyacrylate rubber, fluorocarbon rubber, chlorinated polyethylene rubber, epichlorohydrin rubber, ethylene-vinyl acetate copolymer, styrene-isoprene block copolymer, urethane rubber, and copolymers, blends, and derivatives thereof.

Embodiment 8: The pouched product of any of Embodiments 1 to 7, wherein the elastic or elastomeric materials comprise one or more gums.

Embodiment 9: The pouched product of Embodiment 9, wherein the one or more gums are selected from the group consisting of xanthan gum, guar gum, gum arabic, ghatti gum, gum tragacanth, karaya gum, locust bean gum, gellan gum, and combinations thereof.

Embodiment 10: The pouched product of Embodiment 8 or 9, wherein the one or more gums comprise guar gum.

Embodiment 11: The pouched product of any of Embodiments 1 to 10, wherein the elastic or elastomeric fibers are in the form of fibers consisting essentially of the elastic or elastomeric material.

Embodiment 12: The pouched product of any of Embodiments 1 to 10, wherein the elastic or elastomeric fibers comprise a blend of the one or more elastic or elastomeric materials and one or more additional materials.

Embodiment 13: The pouched product of any of Embodiments 1 to 12, wherein the elastic or elastomeric fibers are in the form of multicomponent fibers comprising: a first component comprising the one or more elastic or elastomeric materials and a second component comprising one or more additional materials.

Embodiment 14: The pouched product of any of Embodiments 1 to 13, wherein the elastic or elastomeric fibers are fibers with a cross-section having a sheath/core structure, an islands-in-the-sea structure, a side-by-side structure, a segmented pie structure, a hollow segmented pie structure, a segmented cross structure, a segmented ribbon structure, or a tipped multilobal structure.

Embodiment 15: The pouched product of any of Embodiments 12 to 14, wherein the one or more additional materials are selected from the group consisting of polyesters, polyamides, polyolefins, polyacrylates, thermoplastic liquid crystalline polymers, and copolymers, blends, and derivatives thereof.

Embodiment 16: The pouched product of any of Embodiments 12 to 15, wherein the one or more additional materials are selected from the group consisting of polybutylene succinate (PBS), poly (butylene succinate)-co-(butylene carbonate) (PBS-co-BC), polyethylene carbonate (PEC), polyhydroxyalkanoates (PHA) such as polyhydroxybutyrate (PHB), poly (glycolic acid) (PGA), polycaprolactone (PCL), polypropylene, and copolymers, blends, and derivatives thereof.

Embodiment 17: The pouched product of any of Embodiments 1 to 16, wherein the plurality of fibers consist essentially of the elastic or elastomeric fibers.

Embodiment 18: The pouched product of any of Embodiments 1 to 16, wherein the plurality of fibers comprises one or more fiber types in addition to the elastic or elastomeric fibers.

Embodiment 19: The pouched product of Embodiment 18, wherein the one or more fiber types are fibers comprising one or more materials selected from the group consisting of wool, cotton, regenerated cellulose, cellulose acetate, cellulose triacetate, cellulose nitrate, ethyl cellulose, cellulose acetate propionate, cellulose acetate butyrate, hydroxypropyl cellulose, methyl hydroxypropyl cellulose, and protein fibers.

Embodiment 20: The pouched product of Embodiment 18 or 19, wherein at least 50% by volume of the fleece material comprises the elastic or elastomeric fibers.

Embodiment 21: The pouched product of any of Embodiments 18 to 20, wherein at least 90% by volume of the fleece material comprises the elastic or elastomeric fibers.

Embodiment 22: The pouched product of any of Embodiments 1 to 21, wherein the oral composition comprises at least one of an active agent and a flavorant in an amount of at least about 0.5% by weight of the oral composition; and a filler in an amount of at least about 30% by weight of the oral composition.

Embodiment 23: The pouched product of Embodiment 23, wherein the filler is selected from the group consisting of a sugar substitute, microcrystalline cellulose, and a combination thereof.

Embodiment 24: The pouched product of any of Embodiments 1 to 23, wherein the oral composition is in particulate form.

Embodiment 25: The pouched product of any of Embodiments 22 to 24, wherein the filler is in the form of a cellulose sponge, and wherein the at least one of an active agent and flavorant is associated with the cellulose sponge via surface absorption or by binder via chemical bond.

Embodiment 26: A method of preparing the pouched product of any of Embodiments 1 to 25, comprising: producing the fleece material comprising a plurality of fibers by: drylaying the plurality of fibers and thermally or chemically bonding the plurality of fibers; spunlacing the plurality of fibers and thermally or chemically bonding the plurality of fibers; or spunlaying the plurality of fibers and thermally or chemically bonding the plurality of fibers; and forming the water-permeable pouch material into the water-permeable pouch and enclosing the oral composition within the water-permeable pouch.

Embodiment 27: A method of preparing the pouched product of any of Embodiments 1 to 25, comprising: providing a nonwoven web comprising splittable fibers comprising the elastic or elastomeric component; treating the nonwoven web to split the splittable fibers to give the elastic or elastomeric fibers to give a water-permeable pouch material; and forming the water-permeable pouch material into the water-permeable pouch and enclosing the oral composition within the water-permeable pouch.

Embodiment 28: A pouched product, comprising: an outer water-permeable pouch defining a cavity and an oral composition comprising at least one water-soluble component within the cavity, wherein the outer water-permeable pouch comprises a fleece material comprising a plurality of fibers, and further comprising an elastic or elastomeric binder between at least a portion of the plurality of fibers.

Embodiment 29: The pouched product of Embodiment 28, wherein the plurality of fibers comprises elastic or elastomeric fibers.

Embodiment 30: The pouched product of Embodiment 28, wherein the plurality of fibers does not comprise elastic or elastomeric fibers.

These and other features, aspects, and advantages of the disclosure will be apparent from a reading of the following detailed description together with the accompanying drawings, which are briefly described below. The disclosure includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosure, in any of its various aspects and embodiments, should be viewed as intended to be combinable unless the context clearly dictates otherwise.

### BRIEF DESCRIPTION OF THE DRAWING

Having thus described aspects of the disclosure in the foregoing general terms, reference will now be made to the accompanying drawing, which is not necessarily drawn to scale. The drawing is an examples only, and should not be construed as limiting the disclosure.

FIG. 1 is a perspective view of a non-limiting fleece-based pouched product 100 according to some embodiments of the present disclosure.

### DETAILED DESCRIPTION

The present disclosure now will be described more fully hereinafter. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art. As used in this specification and the claims, the singular forms “a,” “an,” and “the” include plural referents unless the context clearly dictates otherwise. Reference to “dry weight percent” or “dry weight basis” refers to weight on the basis of dry ingredients (i.e., all ingredients except water). Reference to “wet weight” refers to the weight of the mixture including water. Unless otherwise indicated, reference to “weight percent” of a mixture reflects the total wet weight of the mixture (i.e., including water).

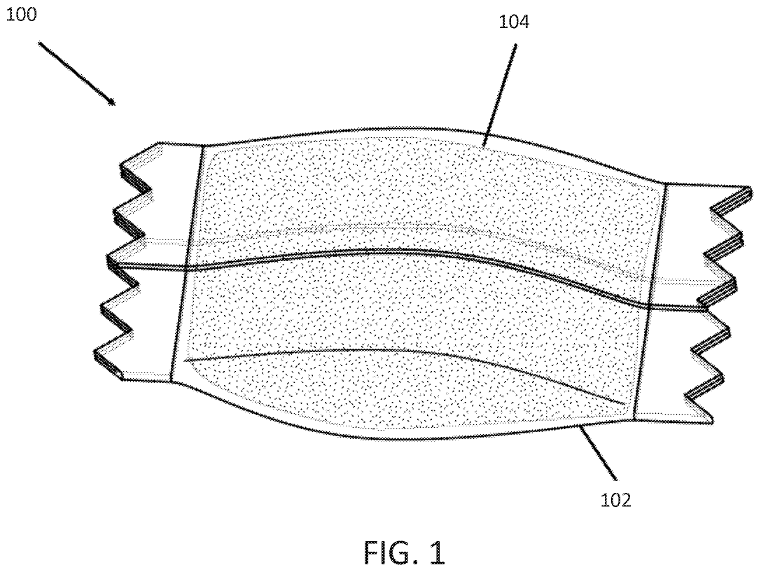

Some embodiments of the disclosure will be described with reference to FIG. 1, and these described embodiments involve oral products having an outer water-permeable pouch containing an oral composition comprising at least one water-soluble component. Referring to FIG. 1, there is shown an embodiment of a pouched product 100. The pouched product 100 includes a moisture-permeable material in the form of a pouch 102 comprising an elastic fleece as described herein, which contains a material 104 comprising the oral composition within a cavity formed in the pouch. It is noted that various modifications can be made to the depicted embodiment, e.g., replacing one or both serrated edges shown with a straight edge. In some embodiments, the fleece can be made of two (or more) pieces of nonwoven fleece (which can be the same or different), e.g., positioned one above the other. The outside edges of the fleeces can be sealed by any sealing method, such as those specifically described below (including, but not limited to, heat sealing, ultrasonic sealing, binder sealing, needle punching sealing, etc.).

### Fleece Material

The disclosure generally provides fleece materials suitable for use, e.g., in products configured for oral use. The term “configured for oral use” as used herein means that the product is provided in a form such that during use, saliva in the mouth of the user causes one or more of the components of the product (e.g., flavoring agents and/or active ingredient) to pass into the mouth of the user. In some embodiments, the product is adapted to deliver one or more components to a user through mucous membranes in the user's mouth and, in some instances, said component is an active ingredient (including, but not limited to, for example, nicotine) that can be absorbed through the mucous membranes in the mouth when the product is used. As provided herein, the products are generally in the form of pouched products. A pouched product is a product comprising an outer water-permeable container in the form of a pouch which contains a material adapted for oral use therein (e.g., a particulate mixture adapted for oral use). The orientation, size, composition, and type of outer water-permeable pouch and the type and nature of the composition adapted for oral use that are illustrated herein are not to be construed as limiting thereof.

The disclosure more specifically provides fleece materials to be employed as an outer water-permeable container (such as those employed in pouched products) which exhibit unique compositions and/or properties and, in particular, to such fleece materials exhibiting enhanced elasticity (e.g., as compared with conventional fleece materials). A “fleece material” as used herein may be formed from various types of fibers, as described in more detail herein below, capable of being formed into fleece fabrics or other pouch materials. For example, fleece materials may be provided in the form of a woven or nonwoven fabric (e.g., air laid webs, carded webs, wet laid webs prepared by paper machine technology, or paper webs). Various types of fleece materials, for example, are described in U.S. Pat. No. 8,931,493 to Sebastian et al.; and US Patent App. Pub. Nos. 2015/0128978 to Sebastian et al., 2016/0000140 to Sebastian et al., and US Patent App. Pub. No. 2016/0073689 to Sebastian et al.; which are all incorporated herein by reference.

Fleece materials are typically fibrous nonwoven webs, e.g., comprising a plurality of fibers. As used herein, the term “fiber” is defined as a basic element of textiles. Fibers are often in the form of a rope- or string-like element. As used herein, the term “fiber” is intended to include fibers, filaments, continuous filaments, staple fibers, and the like. The term “fiber” is defined as a basic element of nonwovens which has a high aspect ratio of, for example, at least about 100 times. In addition, “filaments/continuous filaments” are continuous fibers of extremely long lengths that possess a very high aspect ratio. “Staple fibers” are cut lengths from continuous filaments. Therefore, as used herein, the term “fiber” is intended to include fibers, filaments, continuous filaments, staple fibers, and the like. The term “multicomponent fibers” refers to fibers that comprise two or more components that are different by physical or chemical nature, including bicomponent fibers. Specifically, the term “multicomponent fibers” includes staple and continuous fibers prepared from two or more polymers present in discrete structured domains in the fiber, as opposed to blends where the domains tend to be dispersed, random or unstructured.

The term “nonwoven” is used herein in reference to fibrous materials, webs, mats, batts, or sheets in which fibers are aligned in an undefined or random orientation. The nonwoven fibers are initially presented as unbound fibers or filaments. An important step in the manufacturing of nonwovens involves binding the various fibers or filaments together. The manner in which the fibers or filaments are bound can vary, and include thermal, mechanical and chemical techniques that are selected in part based on the desired characteristics of the final product, as discussed in more detail herein below.

In some embodiments, fleece materials are provided herein which comprise one or more, e.g., a plurality of, fibers comprising one or more components considered to be “elastic” or “elastomeric” in nature; the resulting fibers and fleece material can, in some embodiments, also be considered to be “elastic” or “elastomeric” in nature. Elastic fibers are deformable and generally exhibit superior elongation/reversibility compared to conventional fibers. “Elastic” and “elastomeric,” as used herein, refer to any material (e.g., polymer) that exhibits a degree of elasticity (e.g., capable of returning substantially to its original shape or form after being subjected to stretching or deformation). In some embodiments, such elastic or elastomeric fibers (and fleeces) exhibit high elongation at break (e.g., 400% or greater) and recover fully and rapidly from high elongations up to their breaking point.

Elastomeric fibers can comprise natural and/or synthetic elastic or elastomeric materials. Such fibers can include varying amounts of the elastic or elastomeric material(s), such that the elastomeric fibers can be described as consisting of, consisting essentially of, or comprising the elastic or elastomeric material(s). As such, the elastic or elastomeric materials can be incorporated within fibers of a fleece material in various ways, including, but not limited to, in the form of single-component fibers (e.g., fibers comprising no additional component polymeric materials, e.g., consisting essentially of the elastic or elastomeric material) or in the form of fibers comprising the elastic or elastomeric materials and one or more additional materials, which are typically polymeric materials). The single-polymer fibers can be used alone or in combination with one or more other types of fibers comprising one or more additional component polymeric materials, to produce the disclosed fleece material.

In some embodiments, the elastic or elastomeric material comprises guar gum (also referred to as guar galactomannan), which is a natural polysaccharide comprising the carbohydrate polymer of galactose and mannose. Electrospun fibers of guar gum are known, e.g., as described in Pirzada et al., ACS Omega 4 (6): 10767-10774 (2019), which is incorporated herein by reference in its entirety. In some embodiments, guar gum is incorporated as a component of a fiber, e.g., by compounding or otherwise combining it with an additional component prior to production of the fiber. In some embodiments, guar gum is associated with a fiber, e.g., as a coating thereon or the like. In some embodiments, the guar gum is present substantially uniformly throughout the fiber so as to provide a substantially uniform and consistent degree of elasticity.

Other materials can also be used in place of or in addition to the guar gum in some embodiments, e.g., other gums (e.g., xanthan gum, guar gum, gum arabic, ghatti gum, gum tragacanth, karaya gum, locust bean gum, gellan gum, and combinations thereof), carrageenan, alginate, natural waxes like beeswax, natural latexes (e.g., Couma macrocarpa (leche caspi or sova), loquat (nispero), tunu, elution, or chicle), natural rubbers (e.g., comprising or consisting essentially of isoprene monomers), and petroleum-derived polymers such as butyl rubber, butadiene-styrene, polyvinyl acetate, polyethylene, paraffin, and petroleum waxes.

In some embodiments, the elastic or elastomeric material comprises one or more elastomers, e.g., thermoplastic elastomers (TPEs), which generally exhibit some degree of elasticity and can be processed via thermoplastic processing methods (e.g., can be easily reprocessed and remolded). Thermoplastic elastomers can comprise both crystalline (i.e., “hard”) and amorphous (i.e., “soft”) domains and often comprise a blend or copolymer of two or more polymer types. Where the thermoplastic elastomer comprises a copolymer, it may be prepared, for example, by block or graft polymerization techniques. Thermoplastic elastomeric copolymers can, for example, comprise a thermoplastic component and an elastomeric component. In certain copolymeric thermoplastic elastomers, the physical properties of the material can be controlled by varying the ratio of the monomers and/or the lengths of the segments.

Certain exemplary thermoplastic elastomers can be classified as styrenic elastomers (e.g., styrene block copolymers), polyether elastomers, polysulfide elastomers, polyester and copolyester elastomers, polyurethane elastomers, polyamide elastomers, polyolefin elastomers, including polyolefin blends (TPOs), thermoplastic vulcanizates, and copolymers, blends, and derivatives thereof. Certain specific elastomers that are useful according to the present disclosure include, for example, polyisoprene, butadiene rubber, styrene-butadiene rubber, poly(styrene-b-butadiene-b-styrene) (SBS), poly(styrene-b-ethene-co-butane-b-styrene (SEBS), poly(styrene-b-isoprene-b-styrene), ethylene propylene diene monomer rubber (EPDM rubber), EPDM rubber/polypropylene (EPDM/PP), polychloroprene, acrylonitrile-butadiene rubber, hydrogenated nitrile rubber, butyl rubber, ethylene-propylene rubber (EPM), silicone, silicone rubber, chlorosulfonated polyethylene, polyacrylate rubber, fluorocarbon rubber, chlorinated polyethylene rubber, epichlorohydrin rubber, ethylene-vinyl acetate copolymer, styrene-isoprene block copolymer, urethane rubber, and copolymers, blends, and derivatives thereof. In some embodiments, the elastic or elastomeric material comprises a thermoplastic polyurethane (PU) elastomer or a thermoplastic polyester elastomer.

Exemplary commercially available thermoplastic elastomers include, but are not limited to, OnFlex™, Versaflex™, Dynaflex™, Dynalloy™, Versalloy™, and Versollan™ from PolyOne™ Corporation (Avon Lake, OH); RTP 1200, 1500, 2700, 2800, 2900, and 6000 Series Elastomers from RTP Company (Winona, MN); Elastocon 2800, 8000, STK, SMR, CLR, and OF Series TPEs from Elastocon (Rochester, IL); Enflex® and Ensoft® from Enplast (Turkey); Styroflex® SBS, Elastollan®, and Elasturan® from BASF (Florham Park, NJ); Kraton MD6705, G1643, MD6717, MD6705, G1643 (Kraton Performance Polymers, Inc., Houston, TX); Affinity™, Amplify™, Engage™, Infuse™, Nordel™, and Versify™ from Dow Chemical (Midland, MI); Vistamaxx™, Santoprene™, and Exact™ from ExxonMobil Chemical Company (Houston, TX); Kalrez®, Neoprene, Hytrel®, Surlyn®, Vamac®, and Viton® from DuPont® Chemicals (Wilmington, DE); Pebax® from Arkema (France); Mediprene® and Dryflex® from Elasto (Sweden); Estagrip® and Estane® from Lubrizol Corporation (Wickliffe, OH); Garaflex™, Garathane™, Vythrene™, and Evoprene™ from AlphaGary (Leominster, MA) and Santoprene® from Advanced Elastomer Systems (Newport, CA). Other exemplary elastomeric materials are described, for example, in U.S. Patent Application Publication No. US2010/0029161 to Pourdeyhimi, which is incorporated herein by reference; see also U.S. Pat. No. 5,035,240 to Braun et al. and U.S. Pat. No. 5,540,976 to Shawver et al., and Zapletalova et al., Polyether Based Thermoplastic Polyurethane Melt Blown Nonwovens, Journal of Engineered Fibers and Fabrics, Vol. 1, Issue 1 (2006), which are incorporated herein by reference in their entireties.

The elastic or elastomeric fibers described herein can comprise varying amounts of the elastic or elastomeric material(s). For example, in some embodiments, such fibers consist essentially of or consist of the elastic or elastomeric material. In some embodiments, fibers comprise the elastic or elastomeric material(s) as the predominant component (e.g., comprising 50% or more by volume of the fiber). In some embodiments, fibers comprise the elastic or elastomeric material(s) as a non-predominant component (e.g., comprising less than 50% by volume of the fiber).

In some embodiments, the elastic or elastomeric material is used in combination with one or more additional materials (e.g., one or more polymers). Such combinations can result, for example, from blends of the elastic or elastomeric material and the one or more additional polymers within a single fiber, from multi-component fibers comprising both the elastic or elastomeric material and the one or more additional polymer, and/or from combinations of two or more different fiber types (at least one fiber type comprising the elastic or elastomeric material and at least one fiber type comprising the one or more additional polymers). The one or more additional polymers are not particularly limited. Examples of such additional polymers include polyesters, co-polyesters, polyamides, polyolefins, polyacrylates, or thermoplastic liquid crystalline polymers. Specific examples include biodegradable polymers such as polybutylene succinate (PBS), poly (butylene succinate)-co-(butylene carbonate) (PBS-co-BC), polyethylene carbonate (PEC), polyhydroxyalkanoates (PHA) such as polyhydroxybutyrate (PHB), poly (glycolic acid) (PGA), polycaprolactone (PCL), and combinations thereof. In some embodiments, the blending partner is a polyolefin, such as polypropylene.

In some embodiments, the elastic or elastomeric fibers comprise the elastic or elastomeric material in the form of a blend with one or more additional materials (e.g., one or more polymers). Typically, such elastic or elastomeric fibers comprise a sufficient amount of the elastic or elastomeric material so as to provide fibers in the form of a blend that can be suitably formed into a fiber that can be characterized as elastic or elastomeric. In some embodiments, the blend comprises at least about 40%, at least about 50%, at least about 60% or at least about 70% by weight of the elastic or elastomeric material, such as at least about 90% by weight of the elastic or elastomeric material, such as at least about 95% by weight of the elastic or elastomeric material. Typically where the fleece comprises a plurality of fibers in the form of a blend of an elastic or elastomeric material and one or more additional materials, the blend is substantially homogeneous in composition throughout the fibers.

In some embodiments, the elastic or elastomeric fibers are multi-component fibers, wherein one or more components of the fiber comprises the elastic or elastomeric material and one or more components of the fiber comprises a second elastic or elastic material and/or comprises an additional material as provided herein. It is noted that the composition of the components of such multi-component fibers may, in some embodiments, be selected from the fiber compositions generally described herein (i.e., each component of a multi-component fiber can comprise an elastic or an elastomeric material alone or in combination with one or more additional materials). Non-limiting examples of multi-component fibers include fibers having a sheath/core structure and fibers having an islands-in-the-sea structure, as well as fibers having a side-by-side, segmented pie, hollow segmented pie, segmented cross, segmented ribbon, or tipped multilobal cross-sections. Multi-component fibers are, in some embodiments, referenced as being “splittable” into their individual components, e.g., by the breaking of interfacial bonds between adjacent components of the fibers. Methods for splitting multi-component fibers are generally known in the art and can comprise mechanical, thermal, or chemical means, e.g., applying pressure such as that provided by hydroentangling jets or the like. In some embodiments, this splitting results in the production of microfibers or filaments.

Multi-component fibers are generally known in the art. Briefly, a sheath/core cross-section comprises two components with one component fully surrounding the other (where the core can be concentric or eccentric, and where the components can be in varying volume ratios with respect to one another). An islands-in-the sea cross-section (also known, e.g., as a matrix-fibril cross-section) comprises regions of one component within a matrix of a second component (where the number and size of such regions within the matrix can vary). A side-by-side fiber cross-section comprises two components side by side with respect to one another down the length of the fiber (where the two components each occupy a part of the fiber surface and wherein the two components can be in varying volume ratios with respect to one another). A segmented pie fiber cross-section (also known, e.g., as a “pie wedge” or “citrus” cross-section) comprises wedges similar to slices of pie, the wedges comprising alternating components (where the number and relative volumes of the wedges can vary). A hollow segmented pie is similar to a segmented pie filler, but includes a hollow center core running the length of the fiber. A segmented cross-section comprises alternating regions of different components (where the number and relative volumes of the components can vary). A segmented ribbon cross-section is similar to a segmented cross-section, but is generally flattened in shape. A tipped multilobal cross-section has three or more lobes comprising one or more components with another component present on each lobe (where the number of lobes and the volume ratio of the components can vary). In some embodiments, such cross sections can provide various benefits to the disclosed products, e.g., modifying the physical properties thereof. Non-limiting examples of the types of physical properties that can be modified in some embodiments include wickability, increased surface area with the formulation within the pouch, increased surface area with saliva within the oral cavity, and thus, in some embodiments, pouched products are provided which can exhibit sustained release relative to corresponding pouched products without shaped or multicomponent fibers.

In some embodiments, the fibers are in the form of a core-sheath configuration, e.g., wherein the elastic or elastomeric material is the core or wherein the elastic or elastomeric material is the sheath (wherein the other component is any other material, including, but not limited to, the types of polymers referenced herein below). Again, multi-polymer fibers can be used alone or in combination with one or more other types of fibers comprising one or more additional materials, to produce the disclosed fleece material.

In some embodiments, the fleece material comprises only elastic or elastomeric fibers (e.g., consisting of, consisting essentially of, or comprising any one or more types of the elastic or elastomeric material-containing fibers described herein above). In some embodiments, the fleece material comprises one or more additional fiber types. Where present, other additional fiber types within the fleece materials provided herein are not particularly limited. In some embodiments, other fiber types within the fleece material include, but are not limited to, fibers comprising polymers selected from the group consisting of polyglycolic acid, polylactic acid, polyhydroxyalkanoates, polycaprolactone, polybutylene succinate, polybutylene succinate adipate, polyvinylpyrrolidone, polyvinyl alcohol and combinations and copolymers thereof. In some embodiments, other component fibers within the fleece material may be selected from the groups consisting of wool, cotton, fibers made of cellulosic material, such as regenerated cellulose, cellulose acetate, cellulose triacetate, cellulose nitrate, ethyl cellulose, cellulose acetate propionate, cellulose acetate butyrate, hydroxypropyl cellulose, methyl hydroxypropyl cellulose, protein fibers, and the like. See also, the fiber types set forth in US Pat. Appl. Pub. No. 2014/0083438 to Sebastian et al., which is incorporated by reference herein. In some embodiments, the optional other fiber types within the fleece material comprise regenerated cellulose fibers, which can be prepared by extracting non-cellulosic compounds from wood, contacting the extracted wood with caustic soda, followed by carbon disulfide and then by sodium hydroxide, giving a viscous solution. The solution is subsequently forced through spinneret heads to create viscous threads of regenerated fibers. Example methods for the preparation of regenerated cellulose are provided in U.S. Pat. No. 4,237,274 to Leoni et al; U.S. Pat. No. 4,268,666 to Baldini et al; U.S. Pat. No. 4,252,766 to Baldini et al.; U.S. Pat. No. 4,388,256 to Ishida et al.; U.S. Pat. No. 4,535,028 to Yokogi et al.; U.S. Pat. No. 5,441,689 to Laity; U.S. Pat. No. 5,997,790 to Vos et al.; and U.S. Pat. No. 8,177,938 to Sumnicht, which are incorporated herein by reference. The manner in which regenerated cellulose is made is not limiting, and can include, for example, both the rayon and the Lyocell processes. Various suppliers of regenerated cellulose are known, including Lenzing (Austria), Cordenka (Germany), Aditya Birla (India), and Daicel (Japan).

The overall content of elastic or elastomeric fibers in a given fleece material can vary widely, but is generally that amount sufficient to ensure the desired elasticity of the fleece. In some embodiments, a fleece material is provided which comprises at least about 10%, at least about 20%, at least about 30%, at least about 40%, at least about 50%, at least about 60%, at least about 70%, at least about 80%, at least about 90%, at least about 95%, or at least about 99% of the elastic or elastomeric material, such as about 20% to about 100%, about 20% to about 80%, about 50% to about 100%, or about 50% to about 80% of the elastic or elastomeric fibers, such values based on the total weight of fibers within the fleece material. It is understood that the percentage of the fleece material comprising the elastic or elastomeric fiber(s) will directly affect the elasticity of the fleece material, i.e., the greater the content of elastic or elastomeric fiber(s) (and, in some embodiments, the greater then content of elastic or elastomeric material within such elastic or elastomeric fibers), the greater the elasticity of the fleece material.

The physical parameters of the fibers present in the nonwoven web can vary. For example, the fibers used in the fleece material can have varying size (e.g., length, denier per filament (dpf)) and crimp characteristics. In some embodiments, fibers used in the nonwoven web can be nano fibers, sub-micron fibers, and/or micron-sized fibers. In some embodiments, fibers of the nonwoven webs useful herein can measure about 1.5 dpf (1.67 decitex) to about 2.0 dpf (2.22 decitex), or about 1.6 dpf (1.78 decitex) to about 1.90 dpf (2.11 decitex). In some embodiments, each fiber can measure about 4-10 crimps per cm, or about 5-8 crimps per cm. In some embodiments, each fiber can be a continuous filament fiber. In some embodiments, each fiber can be a staple fiber. Each fiber length can measure about 35 mm to about 60 mm, or about 38 mm to about 55 mm, for example. In some embodiments, it can be advantageous for all fibers in the fleece material to have similar fiber size and crimp attributes to ensure favorable blending and orientation of the fibers in the nonwoven web.

In some embodiments, a heat sealable binder coating or a binder material (e.g., a coating or other additive) may be added to the fibers prior to, during, or after forming the fleece material. As used herein, “heat sealable binder coatings” refers to coating materials, such as acrylic polymer compositions, applied to a substrate (e.g., a nonwoven web or fleece material) and which are capable of sealing seams of individual pouches upon heating. In some embodiments, a binder material can be added to the web fibers before or during the laying of the fibrous web (i.e., before the fibrous web is bonded to form a fleece material). In some embodiments, a binder material can be added to the fleece material after it has been formed. In some embodiments, the binder material is in the form of a liquid coating. In some embodiments, a binding powder can be applied to the fleece material. For example, powdered polyethylene can be used as a binder material. The liquid or powder coating can be applied, for example, between layers of fibers when cross-laying, air laying, or as an after treatment. A short exposure in an oven is sufficient to melt and fuse the binder material.

In some embodiments, an elastic binder can be used. For example, use of an elastic binder between fibers (including elastic/elastomeric fibers and/or non-elastic/non-elastomeric fibers) can give a fleece some degree of elasticity. In some embodiments, elasticity can be imparted to any type of fleece by inclusion of an elastic binder, i.e., the disclosure includes, but is not limited to, embodiments comprising an elastic or elastomeric fleece comprising elastic and non-elastic fibers and an elastic or non-elastic binder; embodiments comprising an elastic or elastomeric fleece comprising only elastic fibers and an elastic or non-elastic binder; and embodiments comprising an elastic or elastomeric fleece comprising only non-elastic fibers and an elastic binder (i.e., all elasticity is provided by the elastic binder).

The fibers of the nonwoven web can be in any arrangement. Generally, the fibers are provided in a somewhat random arrangement. Although the present disclosure focuses on nonwoven webs, it is noted that the pouch materials of the present disclosure can be formed using traditional woven fabrics in place of, or in addition to, a nonwoven web.

In some embodiments, an elastic or elastomeric material-containing nonwoven web as described herein is used as a sole fleece material layer surrounding an oral composition to form a pouched product (referred to in some embodiments as comprising a single-layer deformable fleece). In some embodiments, an elastic or elastomeric material-containing nonwoven web as described herein is used in combination with one or more additional fleece material layers (which can comprise further elastic or elastomeric material-containing nonwoven webs and/or conventional nonwoven webs). The elastic or elastomeric material-containing nonwoven web can be used, e.g., as an interior layer (i.e., in direct contact with the oral composition within the pouch) or as an exterior layer (i.e., exposed directly to the oral cavity during use of the oral product). The number of layers in the pouch material can vary, with example ranges being two to six or two to four layers. The layers of the pouch material can be bonded or affixed to one another using any method in the art, including thermal bonding, stitching, and the like.

In some embodiments, the fleece can deliver actives and flavorants from the inside of the pouch to a consumer's oral cavity through diffusion (e.g., similar to or equivalent to the delivery exhibited by conventional pouched products without an elastic component).

In some embodiments, e.g., if faster or enhanced release/delivery of actives and/or flavorants is desired, consumers can manipulate the oral product within their oral cavity to modify the release/delivery profile. For example, a consumer may press a product between their lip and gum, suck the product, and/or chew the product. Advantageously, manipulation/action within the oral cavity (e.g., chewing, suction, or pressing) can exert force on the elastic fleece. This manipulation can cause the oral product to exhibit some degree of deformation/stretching of the elastic or elastomeric fibers and/or the fleece comprising such elastic or elastomeric fibers. The deformation/stretching of the fleece can result in the opening and/or enlarging of diffusion pores within the fleece, thereby allowing for enhanced delivery of various components (e.g., flavorants, actives etc.) from the oral composition within the product through the fleece to the user's oral cavity. Compression and release within the oral cavity as a result of a pressing/chewing/sucking force in the oral cavity can, in some embodiments, produce a pumping action to accelerate delivery of various components (e.g., flavorants, actives, etc.) from the oral composition within the product to the user's oral cavity.

### Method of Producing Fleece Material

The means of producing elastic fleece materials according to the present disclosure can vary. Web formation can be accomplished by any means known in the art. Nonwoven web formation will typically involve a carding step, which involves deposition of the fibers onto a surface followed by aligning/blending the fibers in a machine direction. Thereafter, the fibrous web is typically subjected to some type of bonding/entanglement including, but not limited to, thermal fusion or bonding, mechanical entanglement, chemical adhesive, or a combination thereof. In one embodiment, the fibrous web is bonded thermally using a calendar (which can provide flat or point bonding), steam jet bonding, or a thru-air oven. Additional bonding methods include ultrasonic bonding and crimping. In some embodiments, needle punching is utilized, wherein needles are used to provide physical entanglement between fibers. In one embodiment, the web is entangled using hydroentanglement, which is a process used to entangle and bond fibers using hydrodynamic forces.

Polymer-laid techniques which can be used to form the elastic fleece materials provided herein include, e.g., spunlaid and Meltblown techniques. Such methods can produce webs with continuous long filaments. Typically, meltblowing provides webs with finer filaments, which can in some embodiments provide a better barrier function than spunlaid techniques.

In some embodiments, the nonwoven web can be formed using a meltblowing technique. Meltblowing is a process wherein a polymer (or polymers) is melted to a liquid state and extruded through a linear die containing numerous (e.g., several hundred or more) small orifices. As the polymer is extruded, streams of hot air are rapidly blown at the polymer, rapidly stretching and/or attenuating the extruded polymer streams to form extremely fine filaments. The air streams typically stretch or attenuate the molten polymer by many orders of magnitude. The stretched polymer fibers are collected as a randomly entangled, self-bonded nonwoven web. Meltblowing generally is described, for example, in U.S. Pat. No. 3,849,241 to Butin, which is incorporated herein by reference in its entirety. A non-limiting method involves melt-blown web forming and thermal bonding consolidation.

Meltblowing is generally capable of providing fibers with relatively small diameters. Diameter and other properties of meltblown fibers can be tailored by modifying various process parameters (e.g., die design, die capillary size, polymer throughput, air velocity, collector distance, and web handling). Attenuating the air pressure affects fiber size, as higher pressures typically yield finer fibers (e.g., up to about 5 microns, such as about 1-5 microns) and lower pressures yield coarser fibers (e.g., up to about 20 microns, such as about 10-20 microns). In some embodiments, the nonwoven web comprises meltblown fibers having average diameters of about 20 microns or less, such as about 15 microns or less or about 10 microns or less or about 5 microns or less (e.g., about 1 to about 10 microns or about 1 to about 5 microns in average diameter). By meltblown standards, the use of a relatively large fiber, such as the ranges provided above, can improve breathability of the resulting fabric.

The design of the meltblowing dies can vary. A conventional Exxon-design meltblown technology (i.e., single-row-capillary or impinging-air type die design) has a single row of spinning capillaries with impinging air streams from both sides of the die tip to draw the fibers. The safe operation pressure of this process is less than about 100 bar, for example. The Biax meltblown die technology (i.e., concentric-air design) features multiple rows of spinning nozzles with individual concentric air jets to attenuate the fibers. It also tolerates high melt pressures at the spinneret and therefore can utilize higher viscosity polymers with a wide operation window. See, e.g., R. Zhao, “Melt Blowing Polyoxymethylene Copolymer,” International Nonwoven Journal, Summer 2005, pp. 19-21 (2005), herein incorporated by reference.

In some embodiments, as referenced above, the elastic or elastomeric fibers comprise multi-component fibers comprising the elastic or elastomeric material and such fibers may, during production of the fleece material, be split into individual constituents. As a non-limiting example, in some embodiments, the nonwoven web comprises filaments (e.g., spunlaid filaments) or fibers (e.g., drylaid fibers) with hollow segmented pie cross-sections comprising the elastic or elastomeric material. The fibers of the nonwoven can, in some embodiments, be split into microfilaments during production of the fleece, such that the resulting fleece material comprises microfilaments comprising the elastic or elastomeric material. These microfilaments can, in some embodiments, result in increased diffusion restriction ability of the fleece.

A binder material can be applied to the fibers of the fibrous web before laying the fibrous web, during formation of the fibrous web, and/or after the fibrous web has been bonded to form a fleece material. After forming the fleece material, heat can be applied to the fleece material in order to activate/at least partially melt the binder material to further bond the fleece material and thereby further enhance the mechanical integrity of the fleece material.

The fleece materials provided herein can have varying thicknesses, porosities, basis weights, and other parameters. The nonwoven web can be formed such that the fiber orientation and basis weight of the pouched product formed therefrom can retain the composition adapted for oral use that is enclosed within the outer water-permeable pouch, but can also allow the flavors of the composition to be enjoyed by the consumer. For example, in some embodiments, the fibrous webs can have a basis weight of about 20 gsm to about 40 gsm, about 30 gsm to about 40 gsm, or about 25 gsm to about 30 gsm. In some embodiments, the fibrous web can have a basis weight of about 28 gsm. Basis weight of a fabric can be measured using ASTM D3776/D3776M-09a (2013) (Standard Test Methods for Mass Per Unit Area (Weight) of Fabric), for example. In some embodiments, the fibrous web can have a thickness of about 0.1 mm to about 0.3 mm (e.g., about 0.11, 0.12, 0.13, 0.14, 0.15, 0.16, 0.17, or 0.18 mm). The fibrous web can have an elongation of about 70% to about 80%, e.g., about 78%. In some embodiments, the fibrous web can have a peak load of about 4 lbs. to about 8 lbs., e.g., about 5.5 lbs. Elongation and breaking strength of textile fabrics can be measured using ASTM D5034-09 (2013) (Standard Test Method for Breaking Strength and Elongation of Textile Fabrics (Grab Test)), for example. In some embodiments, the fibrous web can have a Tensile Energy Absorption (TEA) of about 35 to about 40, e.g., about 37. TEA can be measured, for example, as the work done to break the specimen under tensile loading per lateral area of the specimen.

Porosity is the percentage of void in a material, typically expressed as a fraction, and can vary widely. Air permeability measures the rate of flow of air passing perpendicularly through a given area of fabric at a given pressure difference across the fabric test area over a given time period. Air permeability can be measured for example, using the EDANA-INDA method, e.g., NWSP 70.1 and/or ASTM D737-04 (2012) (Standard Test method for Air Permeability of Textile Fabrics), for example. In some embodiments, the fibrous web can have an air permeability of greater than about 2,000 ml/min/cm² or greater than about 10,000 ml/min/cm².

In some embodiments, a fleece material is provided or presented herein in the form of a continuous material, e.g., a full bobbin of fleece material that is processed at one time. As such, the fleece material is generally provided so as to allow for the subsequent production of numerous pouched products from one piece of fleece material.

### Oral Product

The elastic fleece materials described herein can be used to enclose an oral composition 104, forming an oral pouched product, which oral compositions will be described herein with reference to FIG. 1. The oral composition within the pouch can vary, but will typically include at least one active ingredient and/or at least one flavorant. The composition of the disclosure may generally be prepared, for example, by dry-blending dry ingredients, such as fillers, active ingredients, salts, buffers, flavoring agents, and the like, and combining the dry mixture with any liquid ingredients, such as humectants, followed by placing the composition in a pouch. Example composition ingredients are provided below.

The oral composition 104 contained within such a pouched product is not particularly limited, and can comprise any filling composition, including those that can be included within conventional, fleece-based pouched products. Such compositions are generally mixtures, e.g., particulate mixtures, of two or more components and as such, the compositions are, in some cases, referenced herein below as “mixtures.” Oral composition 104 can be, in some embodiments, a particulate material. It is noted that such pouches are not limited to containing an oral composition in the form of a particulate mixture. In some embodiments, the material adapted for oral use within the pouch can be, e.g., a liquid or gel material.

In some embodiments, oral composition 104 can be in the form of a sponge substrate, such as a cellulose sponge substrate, wherein one or more components as described herein (e.g., actives and/or flavorants) are held within the sponge matrix, e.g., via surface absorption or via association with the sponge via a binder/chemical bond. Such components can be released from the sponge substrate in the user's oral cavity by chewing, suction, or press force. The sponge structure can deform and recover under applied force, thus providing a pumping effect to enhance the delivery of actives and/or flavoring agents in some embodiments. The composition and form of a sponge substrate can vary widely; for example, the sponge can be rectangular, oval, or in the form of multiple spheres held within the pouch. Various types of open cell sponge materials have large specific surface areas available for association with actives and/or flavorants and can be used in some embodiments. In some embodiments, the sponge substrate is biodegradable. In some embodiments, the sponge substrate is larger in size than a conventional powder/particulate filler (which can avoid leakage through the pores of the fleece when the oral product is manipulated in the oral cavity, e.g., via sucking, chewing, or pressing). A sponge substrate filler can be a single unit in the pouch or can be present as multiple units within the pouch (which can be of the same shape and/or composition or which can vary in shape and/or composition). For example, such units can be, e.g., square, spherical, etc.

As used herein, reference to “porous sponge” refers to a material with a large pore volume typically capable of liquid absorption and characterized by resilience. The sponge can be constructed of various materials, including cellulose, synthetic polymers such as polyethylene, polyurethane, or Plastazote® crosslinked polyethylene, rubber materials such as EPDM (ethylene propylene diene monomer), PVC/nitrile or neoprene rubber, silicone, and the like. For the sake of brevity, the remainder of the disclosure focuses on cellulose sponge materials. However, the various characteristics and parameters associated with cellulose sponges herein could also apply to other sponge materials.

Cellulose sponges can be formed using any method known in the art. In some embodiments, the sponge material includes a regenerated cellulose material. As is known in the art, regenerated cellulose can be formed by extracting non-cellulosic compounds from wood, contacting the extracted wood with caustic soda, followed by carbon disulfide and then by sodium hydroxide, giving a viscous solution. Example methods for the preparation of regenerated cellulose are provided in U.S. Pat. No. 4,237,274 to Leoni et al; U.S. Pat. No. 4,268,666 to Baldini et al; U.S. Pat. No. 4,252,766 to Baldini et al.; U.S. Pat. No. 4,388,256 to Ishida et al.; U.S. Pat. No. 4,535,028 to Yokogi et al.; U.S. Pat. No. 5,441,689 to Laity; U.S. Pat. No. 5,997,790 to Vos et al.; and U.S. Pat. No. 8,177,938 to Sumnicht, which are incorporated herein by reference.

Regenerated cellulose sponges are typically formed using a mixture of a regenerated cellulose solution formed as noted above, reinforcing fibers such as linen, jute, cotton, regenerated cellulose fibers and the like, and an inorganic pore-forming agent. In general, this mixture is a viscous solution containing from 5 to 8% by weight of cellulose, 6 to 100% by weight reinforcing fibers, based on the weight of the cellulose, and 900 to 2500% by weight of the inorganic pore-forming agent, based on the weight of the cellulose. The pore-forming agent is generally comprised of crystals of sodium sulfate decahydrate or other alkali metal salts high in water of crystallization, such as sodium acetate trihydrate, sodium carbonate decahydrate, trisodium phosphate dodecahydrate, disodium phosphate dodecahydrate, potassium sodium tartrate tetrahydrate and the like. The final pore size will be dependent upon the size of the pore-forming agent crystals. If desired, a colorant, such as a dye or pigment, can be added to the mixture as well, or added to the sponge after formation thereof, such as by spraying the colorant on the sponge or dipping the sponge into a colorant solution.

The mixture is then introduced into desired molds or extruded through desired shaped orifices and heated such that the cellulosic solution coagulates and regenerates, and the pore-forming agent is melted. After regeneration, the shaped mass is subjected to washing with water to remove the soluble salt and other constituents, optionally desulphurized, optionally bleached, and optionally treated with a solution of a plasticizer such as glycerol or propylene glycol. See, for example, the cellulose sponge manufacturing methods set forth in WO2010105806 to Hunger et al., and U.S. Pat. No. 3,276,072 to Politzer et al. and U.S. Pat. No. 3,131,076 to Richardson et al., which are incorporated herein by reference. Cellulose sponge materials are commercially available from suppliers such as SPONTEX.

The shape and size of the sponge can vary without departing from the present disclosure. For example, the cellulose sponge, in cross-section, can have a circular, rectangular, square, oval, triangular, or multilobal shape. The size should be suitable for insertion into the oral cavity.

The cellulose sponge will typically have a density in the range of about 20 to about 60 kg/m³. The cellulose sponge is typically highly absorbent, with embodiments exhibiting the ability to absorb as much as 20 times the dry weight of the cellulose sponge (e.g., about 10 to about 20 times the dry weight). Example pore size ranges include about 4 nm to about 1000 microns, such as about 1 to about 500 microns or about 1 to about 100 microns.

In some embodiments, the cellulose sponge (and oral products made therewith) provided herein is biodegradable and/or compostable. The term “biodegradable” as used in reference to a plastic material refers to a polymer that degrades under aerobic and/or anaerobic conditions in the presence of bacteria, fungi, algae, and/or other microorganisms into carbon dioxide/methane, water and biomass, although materials containing heteroatoms can also yield other products such as ammonia or sulfur dioxide. “Biomass” generally refers to the portion of the metabolized materials incorporated into the cellular structure of the organisms present or converted to humus fractions indistinguishable from material of biological origin. By “compostable” is meant that the material is designed to biodegrade in the conditions of a composter (e.g., at lower temperatures than industrial compositing plants) and by “oxo-degradable” is meant that the material (which typically comprises suitable additives) fragments into microplastics or chemically decomposes through oxidation.

Biodegradation can be evaluated, e.g., by weight loss of the oral product over time. In some embodiments, 100% biodegradation of all biodegradable components is obtained over a period of less than 10 years, less than 5 years, less than 2 years, less than 1 year, or less than 6 months at ambient temperature (e.g., 20 °C) and aerobic conditions; it is understood that such times will be decreased with exposure to elevated temperatures. Certain oral products provided herein successfully test as “biodegradable” according to the ASTM standards mentioned herein (e.g., according to one or more of ASTM D5338, ASTM D5511, ASTM D5526, ASTM D5988, ASTM D6400, and ASTM D6691), and/or to “Readily Biodegradability” standards according to OECD 3018B.

In some embodiments, the cellulose sponge and/or oral products provided herein can be described as being substantially (or wholly) free of TiO₂. By “substantially free” is meant that no TiO₂ has been intentionally added. For example, some embodiments can be characterized as having less than 0.001% by weight of TiO₂, or less than 0.0001%, or even 0% by weight of TiO₂.

The cellulose sponge is treated with an oral composition. The oral composition may include various components, such as active ingredients, flavorants, fillers, binders, humectants, sweeteners, salts, and the like. Example oral composition components are set forth within this disclosure.

The oral composition can be associated with the cellulose sponge in various ways. For example, the cellulose sponge can be treated with a powder, solution, or slurry comprising the oral composition by, for example, soaking the cellulose sponge in the oral composition or spraying the oral composition onto the sponge. In some embodiments, the oral composition is in the form of one or more capsules (such as microcapsules) containing an internal payload that includes at least one component (e.g., an active ingredient or flavorant) intended to be delivered to the oral cavity. The capsules could be included in a slurry used to treat the cellulose sponge. Alternatively, the oral composition could be added during formation of the cellulose sponge material, such as by mixing the oral composition with the viscous cellulose solution prior to the molding step noted above. In this manner, the oral composition is carried by the cellulose sponge through one or more of surface coating and absorption within the pores of the cellulose sponge.

In some embodiments, the oral composition is absorbed and/or adsorbed within the sponge material, wherein absorption is understood to relate to the process by which the oral composition, typically in liquid form, is drawn into the porous structure of the sponge, and adsorption is understood to relate to gathering of the oral composition as a surface layer on the sponge material.

In some embodiments, a moisture-permeable packet or pouch can act as a container for use of the oral composition (e.g., particulate material) within. For example, the pouch provides a liquid-permeable container of a type that may be considered to be similar in character to the mesh-like type of material that is used for the construction of a tea bag. If desired, flavoring ingredients, disintegration aids, and other desired components, may be incorporated within, or applied to, the pouch material. Suitable packets, pouches or containers of the type used for the manufacture of oral products, which can be modified according to the present disclosure (e.g., to comprise the disclosed fleece materials), are available under the tradenames CatchDry, Ettan, General, Granit, Goteborgs Rape, Grovsnus White, Metropol Kaktus, Mocca Anis, Mocca Mint, Mocca Wintergreen, Kicks, Probe, Prince, Skruf and TreAnkrare. A pouch type of product similar in shape and form to some embodiments of a pouched product described herein is commercially available as ZONNIC (distributed by Niconovum AB). Additionally, pouch type products generally similar in shape and form to some embodiments of a pouched product are set forth as snuff bag compositions E-J in Example 1 of PCT WO 2007/104573 to Axelsson et al., which is incorporated herein by reference, which are produced using excipient ingredients and processing conditions that can be used to manufacture pouched products as described herein. Further pouch types of products comprising nicotine are marketed under the brand name VELO®.

Such oral compositions can comprise, e.g., one or more active ingredients and/or one or more flavorants, and various other optional ingredients (e.g., fillers, pH adjusters/buffering agents, colorants, humectants, salts, sweeteners, and the like). Various additives can be included in the disclosed mixture; for example, the mixture can be processed, blended, formulated, combined and/or mixed with other materials or ingredients. The additives can be artificial, or can be obtained or derived from herbal or biological sources. Examples of further types of additives include thickening or gelling agents (e.g., fish gelatin), emulsifiers, oral care additives (e.g., thyme oil, eucalyptus oil, and zinc), preservatives (e.g., potassium sorbate and the like), zinc or magnesium salts selected to be relatively water soluble for compositions with greater water solubility (e.g., magnesium or zinc gluconate) or selected to be relatively water insoluble for compositions with reduced water solubility (e.g., magnesium or zinc oxide), disintegration aids, or combinations thereof. See, for example, those representative components, combination of components, relative amounts of those components, and manners and methods for employing those components, set forth in U.S. Pat. No. 9,237,769 to Mua et al., U.S. Pat. No. 7,861,728 to Holton, Jr. et al., US Pat. App. Pub. No. 2010/0291245 to Gao et al., and US Pat. App. Pub. No. 2007/0062549 to Holton, Jr. et al., each of which is incorporated herein by reference. Typical inclusion ranges for such additional additives can vary depending on the nature and function of the additive and the intended effect on the final mixture, with an example range of up to about 10% by weight, based on total weight of the mixture (e.g., about 0.1 to about 5% by weight).

In some embodiments, one or more of the components described herein is provided in the form of one or more capsules (such as microcapsules) containing an internal payload that includes any such component intended to be delivered to the oral cavity. In embodiments where the oral composition is in the form of or comprises capsules, at least one encapsulant will be present, which is typically a polymeric material. The form of the encapsulated oral composition can vary, and will typically include embodiments such as core/shell capsules and encapsulants containing a polymer matrix with a dispersed phase including the oral composition. In some embodiments, the encapsulated oral composition includes an outer shell or coating incorporating a material such as wax, gelatin, cyclodextrin, hydroxypropylmethylcellulose (“HPMC”), or alginate, and an inner payload incorporating one or more oral composition components. In this manner, a plurality of encapsulated oral composition units may be incorporated within the pouched product, and during use of the product, degradation of the outer shell or coating of the encapsulated oral composition units allows release of the allows release of the oral composition within the oral cavity. For example, the encapsulated oral composition can be designed to degrade when contacted with moisture through use of water-soluble polymers in the construction of the encapsulated oral composition. Alternatively, the encapsulated oral composition could be designed for physical destruction through mastication of the oral product in the oral cavity.

The encapsulated oral composition units used in the oral product may be uniform or varied in size, weight, and shape. A representative encapsulated oral composition unit is generally spherical in shape. However, suitable encapsulated oral composition units may have other types of shapes, such as generally rectilinear, oblong, elliptical, or oval shapes. Example encapsulated oral composition units may have diameters of less than about 1,000 microns, such as diameters in the range of about 1 to about 750 microns, or about 10 micron to about 500 microns. In some embodiments, larger encapsulated oral composition units may be utilized. For example, encapsulated oral composition units utilized in the product may have a size of about 0.5 mm to about 5 mm or about 0.6 mm to about 3 mm in diameter.

The total weight of the encapsulated oral composition units contained within an oral product may vary, but is typically greater than about 0.5 mg, often greater than about 1 mg, and can be greater than about 5 mg. The total weight of the encapsulated oral composition units is typically less than about 50 mg, often less than about 250 mg, and can be less than about 10 mg.

The relative weight of the encapsulated oral composition units in the oral product may vary. Example weight ranges are from about 0.1 percent to about 10 percent, often about 0.2 percent to about 5 percent, based on the total weight of the oral product.

The encapsulated oral composition units can be formed using, for example, any encapsulating technology known in the art. For example, the capsules can be formed using any of various chemical encapsulation techniques such as solvent evaporation, solvent extraction, organic phase separation, interfacial polymerization, simple and complex coacervation, in-situ polymerization, liposome encapsulation, and nanoencapsulation. Alternatively, physical methods of encapsulation could be used, such as injection molding, spheronization, granulation, extrusion, microfluidics, spray coating, pan coating, fluid bed coating, annular jet coating, spinning disk atomization, spray cooling, spray drying, spray chilling, stationary nozzle coextrusion, centrifugal head coextrusion, or submerged nozzle coextrusion.

Coacervation is a colloid phenomenon that begins with a solution of a colloid in an appropriate solvent. Depending on the nature of the colloid, various changes can bring about a reduction of the solubility of the colloid. As a result of this reduction, a significant portion of the colloid can be separated out into a new phase, thus forming a two-phase system, with one being rich and the other being poor in colloid concentration. The colloid-rich phase in a dispersed state appears as amorphous liquid droplets called coacervate droplets. Upon standing, these coalesce into one clear homogenous colloid-rich liquid layer, known as the coacervate layer, which can be deposited so as to produce the wall material of the resultant encapsulated pH adjusting agent.

Simple coacervation can be effected either by mixing two colloidal dispersions, one having a high affinity for water, or it can be induced by adding a strongly hydrophilic substance such as alcohol or sodium sulfate. A water-soluble polymer is concentrated in water by the action of a water miscible, non-solvent for the emerging polymer (e.g., gelatin) phase. Ethanol, acetone, dioxane, isopropanol and propanol are exemplary solvents that can cause separation of a coacervate such as gelatin, polyvinyl alcohol, or methyl cellulose. Phase separation can be effected by the addition of an electrolyte such as an inorganic salt to an aqueous solution of a polymer such as gelatin, polyvinyl alcohol, or carboxymethylcellulose.

Complex coacervation can be induced in systems having two dispersed hydrophilic colloids of opposite electric charges. Neutralization of the overall positive charges on one of the colloids by the negative charge on the other is used to bring about separation of the polymer-rich complex coacervate phase. The gelatin-gum arabic (gum acacia) system is one known complex coacervation system.

Organic phase separation is sometimes more simply referred to as “water-in-oil” encapsulation. In this case, the polar core is dispersed into an oily or non-polar continuous medium. The wall material is then dissolved in this continuous medium.

Regardless of the encapsulation methodology employed, the outer wall or matrix material and/or coating material and solvents used to form the encapsulated oral composition units of the disclosure can vary. Classes of materials that are typically used as wall/shell or coating materials include proteins, polysaccharides, starches, waxes, fats, natural and synthetic polymers, and resins. Exemplary materials for use in the encapsulation process used to form the encapsulated oral composition units include gelatin, acacia (gum arabic), polyvinyl acetate, potassium alginate, carob bean gum, potassium citrate, carrageenan, potassium polymetaphosphate, citric acid, potassium tripolyphosphate, dextrin, polyvinyl alcohol, povidone, dimethylpolysiloxane, mannitol, dimethyl silicone, refined paraffin wax, ethylcellulose, bleached shellac, maltodextrin, modified food starch, sodium alginate, guar gum, sodium carboxymethylcellulose, hydroxypropyl cellulose, sodium citrate, hydroxypropylmethylcellulose, sodium ferrocyanide, sodium polyphosphates, locust bean gum, methylcellulose, sodium trimetaphosphate, methyl ethyl cellulose, sodium tripolyphosphate, microcrystalline wax, tannic acid, petroleum wax, terpene resin, tragacanth, polyethylene, xanthan gum, and polyethylene glycol.

Encapsulation methods are described, for example, in Gutcho, Microcapsules and Microencapsulation Techniques (1976); Gutcho, Microcapsules and Other Capsules Advances Since 1975 (1979); Kondo, Microcapsule Processing and Technology (1979); Iwamoto et al., AAPS Pharm. Sci. Tech. 2002 3 (3): article 25; U.S. Pat. No. 3,550,598 to McGlumphy; U.S. Pat. No. 4,889,144 to Tateno et al.; U.S. Pat. No. 5,004,595 to Cherukuri et al.; U.S. Pat. No. 5,690,990 to Bonner; U.S. Pat. No. 5,759,599 to Wampler et al.; U.S. Pat. No. 6,039,901 to Soper et al.; U.S. Pat. No. 6,045,835 to Soper et al.; U.S. Pat. No. 6,056,992 to Lew; U.S. Pat. No. 6,106,875 to Soper et al.; U.S. Pat. No. 6,117,455 to Takada et al.; U.S. Pat. No. 6,325,859 to DeRoos et al.; U.S. Pat. No. 6,482,433 to DeRoos et al.; U.S. Pat. No. 6,612,429 to Dennen; and U.S. Pat. No. 6,929,814 to Bouwmeesters et al.; U.S. Pat. Appl. Pub. Nos. 2006/0174901 to Karles et al. and 2007/0095357 to Besso et al.; and PCT WO2007/037962 to Holton et al.; each of which is incorporated herein by reference. Commercially available encapsulating techniques include those marketed under the trade names ULTRASEAL™ and PERMASEAL™ available from Givaudan headquartered in Vernier, Switzerland.

Certain components that can advantageously be included in the mixtures within some embodiments of the pouches provided herein are outlined generally below; however, it is to be understood that the discussion below is not intended to be limiting of the components that can be incorporated within the disclosed pouches. In some embodiments, the composition within the pouch provided herein includes only saliva-soluble materials. In some embodiments, the composition within the pouch can be orally dissolvable. The composition can be configured to provide sustained release of active ingredient(s) and/or flavorant(s) upon contact with the saliva in the mouth of a user. After use, the entire composition can, in some embodiments, dissolve completely, leaving only the fleece material behind.

In some embodiments, the composition within the pouched product can be adapted to or configured to at least partially dissolve or completely dissolve in about 5 minutes or longer, about 15 minutes or longer, about 30 minutes or longer, or about an hour or longer. In some embodiments, the composition can be configured to at least partially dissolve or completely dissolve in no less than 30 minutes, no less than 45 minutes, or no less than an hour. In some embodiments, the composition can be configured to at least partially dissolve or completely dissolve in a time of about 30 seconds to about 30 minutes, about 1 minute to about 25 minutes, about 5 minutes to about 20 minutes, or about 5 minutes to about 15 minutes.

### Filler Component

The oral composition within the pouches as described herein can include at least one particulate filler component. Such particulate filler components may fulfill multiple functions, such as enhancing certain organoleptic properties such as texture and mouthfeel, enhancing cohesiveness or compressibility of the product, and the like. Generally, fillers are porous particulate materials and are cellulose-based. For example, suitable fillers are any non-tobacco plant material or derivative thereof, including cellulose materials derived from such sources. Examples of cellulosic non-tobacco plant material include cereal grains (e.g., maize, corn, oat, barley, rye, buckwheat, and the like), sugar beet (e.g., FIBREX® brand filler available from International Fiber Corporation), bran fiber, and mixtures thereof. Non-limiting examples of derivatives of non-tobacco plant material include starches (e.g., from potato, wheat, rice, corn), natural cellulose, and modified cellulosic materials.

“Starch” as used herein may refer to pure starch from any source, modified starch, or starch derivatives. Starch is present, typically in granular form, in almost all green plants and in various types of plant tissues and organs (e.g., seeds, leaves, rhizomes, roots, tubers, shoots, fruits, grains, and stems). Starch can vary in composition, as well as in granular shape and size. Often, starch from different sources has different chemical and physical characteristics. A specific starch can be selected for inclusion in the mixture based on the ability of the starch material to impart a specific organoleptic property to composition. Starches derived from various sources can be used. For example, major sources of starch include cereal grains (e.g., rice, wheat, and maize) and root vegetables (e.g., potatoes and cassava). Other examples of sources of starch include acorns, arrowroot, arracacha, bananas, barley, beans (e.g., favas, lentils, mung beans, peas, chickpeas), breadfruit, buckwheat, canna, chestnuts, colacasia, katakuri, kudzu, malanga, millet, oats, oca, Polynesian arrowroot, sago, sorghum, sweet potato, quinoa, rye, tapioca, taro, tobacco, water chestnuts, and yams. Certain starches are modified starches. A modified starch has undergone one or more structural modifications, often designed to alter its high heat properties. Some starches have been developed by genetic modifications, and are considered to be “modified” starches. Other starches are obtained and subsequently modified. For example, modified starches can be starches that have been subjected to chemical reactions, such as esterification, etherification, oxidation, depolymerization (thinning) by acid catalysis or oxidation in the presence of base, bleaching, transglycosylation and depolymerization (e.g., dextrinization in the presence of a catalyst), cross-linking, enzyme treatment, acetylation, hydroxypropylation, and/or partial hydrolysis.

Other starches are modified by heat treatments, such as pregelatinization, dextrinization, and/or cold-water swelling processes. Certain modified starches include monostarch phosphate, distarch glycerol, distarch phosphate esterified with sodium trimetaphosphate, phosphate distarch phosphate, acetylated distarch phosphate, starch acetate esterified with acetic anhydride, starch acetate esterified with vinyl acetate, acetylated distarch adipate, acetylated distarch glycerol, hydroxypropyl starch, hydroxypropyl distarch glycerol, starch sodium octenyl succinate.

Additional examples of potential fillers include maltodextrin, dextrose, calcium carbonate, calcium phosphate, lactose, and sugar alcohols. Combinations of fillers can also be used. In some embodiments, the filler comprises or is a mixture of glucose and starch-derived polysaccharides. One such suitable mixture of glucose and starch-derived polysaccharides is EMDEX®, available from JRS PHARMA LP, USA, 2981 Route 22, Patterson, NY 12563-2359.

In some embodiments, the particulate filler is a cellulose material or cellulose derivative. One particularly suitable particulate filler for use in the compositions described herein is microcrystalline cellulose (“mcc”). The mcc may be synthetic or semi-synthetic, or it may be obtained entirely from natural celluloses. The mcc may be selected from the group consisting of AVICEL® grades PH-100, PH-102, PH-103, PH-105, PH-112, PH-113, PH-200, PH-300, PH-302, VIVACEL® grades 101, 102, 12, 20 and EMOCEL® grades 50M and 90M, and the like, and mixtures thereof. In one embodiment, the composition comprises mcc as the particulate filler. The quantity of mcc present may vary according to the desired properties.

The amount of filler can vary, but is typically up to about 90 percent of the composition by weight, based on the total weight of the composition. A typical range of filler (e.g., mcc) within the composition can be from about 10 to about 85 percent by total weight of the composition, for example, from about 10, about 15, about 20, about 25, or about 30, to about 45, about 50, about 65, or about 75 weight percent (e.g., about 20 to about 80 weight percent or about 25 to about 75 weight percent). In some embodiments, the amount of filler is at least about 10 percent by weight, such as at least about 20 percent, or at least about 25 percent, or at least about 30 percent, or at least about 40 percent, or at least about 50 percent, based on the total weight of the composition.

In one embodiment, the filler further comprises a cellulose derivative or a combination of such derivatives. In some embodiments, the composition comprises from about 1 to about 10% of the cellulose derivative by weight, based on the total weight of the composition, with some embodiments comprising about 1 to about 5% by weight of cellulose derivative. In some embodiments, the cellulose derivative is a cellulose ether (including carboxyalkyl ethers), meaning a cellulose polymer with the hydrogen of one or more hydroxyl groups in the cellulose structure replaced with an alkyl, hydroxyalkyl, or aryl group. Non-limiting examples of such cellulose derivatives include methylcellulose, hydroxypropylcellulose (“HPC”), hydroxypropylmethylcellulose (“HPMC”), hydroxyethyl cellulose, and carboxymethylcellulose (“CMC”). In one embodiment, the cellulose derivative is one or more of methylcellulose, HPC, HPMC, hydroxyethyl cellulose, and CMC. In one embodiment, the cellulose derivative is HPC. In some embodiments, the composition comprises from about 1 to about 3% HPC by weight, based on the total weight of the composition.

### Active Ingredient

The composition as disclosed herein may comprise one or more active ingredients. As used herein, an “active ingredient” refers to one or more substances belonging to any of the following categories: API (active pharmaceutical substances), food additives, natural medicaments, and naturally occurring substances that can have an effect on humans. Example active ingredients include any ingredient known to impact one or more biological functions within the body, such as ingredients that furnish pharmacological activity or other direct effect in the diagnosis, cure, mitigation, treatment, or prevention of disease, or which affect the structure or any function of the body of humans (e.g., provide a stimulating action on the central nervous system, have an energizing effect, an antipyretic or analgesic action, or an otherwise useful effect on the body). In some embodiments, the active ingredient may be of the type generally referred to as dietary supplements, nutraceuticals, “phytochemicals” or “functional foods”. These types of additives are sometimes defined in the art as encompassing substances typically available from naturally-occurring sources (e.g., botanical materials) that provide one or more advantageous biological effects (e.g., health promotion, disease prevention, or other medicinal properties), but are not classified or regulated as drugs.

Non-limiting examples of active ingredients include those falling in the categories of botanical ingredients, stimulants, amino acids, and/or pharmaceutical, nutraceutical, and medicinal ingredients (e.g., vitamins, such as B6, B12, and C, and/or cannabinoids, such as tetrahydrocannabinol (THC) and cannabidiol (CBD)). Each of these categories is further described herein below. The particular choice of active ingredients will vary depending upon the desired flavor, texture, and desired characteristics of the particular product.

The particular percentages of active ingredients present will vary depending upon the desired characteristics of the particular product. Typically, an active ingredient or combination thereof is present in a total concentration of at least about 0.001% by weight of the composition, such as in a range from about 0.001% to about 30%. In some embodiments, the active ingredient or combination of active ingredients is present in a concentration from about 0.1% w/w to about 10%, about 20%, or about 30% by weight, such as, e.g., from about 0.5% w/w to about 30%, from about 0.5% w/w to about 20%, from about 0.5% w/w to about 10%, from about 1% to about 10%, or from about 1% to about 5% by weight, based on the total weight of the composition. In some embodiments, the active ingredient or combination of active ingredients is present in a concentration of from about 0.001%, about 0.01%, about 0.1%, or about 1%, up to about 20% by weight, such as, e.g., from about from about 0.001%, about 0.002%, about 0.003%, about 0.004%, about 0.005%, about 0.006%, about 0.007%, about 0.008%, about 0.009%, about 0.01%, about 0.02%, about 0.03%, about 0.04%, about 0.05%, about 0.06%, about 0.07%, about 0.08%, about 0.09%, about 0.1%, about 0.2%, about 0.3%, about 0.4%, about 0.5% about 0.6%, about 0.7%, about 0.8%, or about 0.9%, to about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% by weight, based on the total weight of the composition. Further suitable ranges for specific active ingredients are provided herein below.

### Botanical

In some embodiments, the active ingredient comprises a botanical ingredient. As used herein, the term “botanical ingredient” or “botanical” refers to any plant material or fungal-derived material, including plant material in its natural form and plant material derived from natural plant materials, such as extracts or isolates from plant materials or treated plant materials (e.g., plant materials subjected to heat treatment, fermentation, bleaching, or other treatment processes capable of altering the physical and/or chemical nature of the material). For the purposes of the present disclosure, a “botanical” includes, but is not limited to, “herbal materials,” which refer to seed-producing plants that do not develop persistent woody tissue and are often valued for their medicinal or sensory characteristics (e.g., teas or tisanes). Reference to botanical material as “non-tobacco” is intended to exclude tobacco materials (i.e., does not include any Nicotiana species).

When present, a botanical is typically at a concentration of from about 0.01% w/w to about 10% by weight, such as, e.g., from about from about 0.01% w/w, about 0.05%, about 0.1%, or about 0.5%, to about 1%, about 2%, about 3%, about 4%, about 5%, about 6%, about 7%, about 8%, about 9%, or about 10%, about 11%, about 12%, about 13%, about 14%, or about 15% by weight, based on the total weight of the composition.

The botanical materials useful in the present disclosure may comprise, without limitation, any of the compounds and sources set forth herein, including mixtures thereof. Certain botanical materials of this type are sometimes referred to as dietary supplements, nutraceuticals, “phytochemicals” or “functional foods.” Certain botanicals, as the plant material or an extract thereof, have found use in traditional herbal medicine, and are described further herein.

Non-limiting examples of non-tobacco botanical materials include without limitation acai berry (Euterpe oleracea martius), acerola (Malpighia glabra), alfalfa, allspice, Angelica root, anise (e.g., star anise), annatto seed, apple (Malus domestica), apricot oil, ashwagandha, Bacopa monniera, baobab, basil (Ocimum basilicum), bay, bee balm, beet root, bergamot, blackberry (Morus nigra), black cohosh, black pepper, black tea, blueberries, boldo (Peumus boldus), borage, bugleweed, cacao, calamus root, camu (Myrcaria dubia), cannabis/hemp, caraway seed, cardamom, cassis, catnip, catuaba, cayenne pepper, Centella asiatica, chaga mushroom, Chai-hu, chamomile, cherry, chervil, chive, chlorophyll, chocolate, cilantro, cinnamon (Cinnamomum cassia), citron grass (Cymbopogon citratus), citrus, clary sage, cloves, coconut (Cocos nucifera), coffee, comfrey leaf and root, cordyceps, coriander seed, cranberry, cumin, curcumin, damiana, dandelion, Dorstenia arifolia, Dorstenia odorata, Echinacea, elderberry, elderflower, endro (Anethum graveolens), evening primrose, eucalyptus, fennel, feverfew, flax, Galphimia glauca, garlic, ginger (Zingiber officinale), Gingko biloba, Ginseng, goji berries, goldenseal, grape seed, grapefruit, grapefruit rosé (Citrus paradisi), graviola (Annona muricata), green tea, guarana, gutu kola, hawthorn, hazel, hemp, hibiscus flower (Hibiscus sabdariffa), honeybush, hops, jiaogulan, jambu (Spilanthes oleraceae), jasmine (Jasminum officinale), juniper berry (Juniperus communis), Kaempferia parviflora (Thai ginseng), kava, laurel, lavender, lemon (Citrus limon), lemon balm, lemongrass, licorice, lilac, Lion's mane, lutein, maca (Lepidium meyenii), mace, marjoram, matcha, milk thistle, mints (menthe), mulberry, Nardostachys chinensis, nutmeg, olive, oolong tea, orange (Citrus sinensis), oregano, papaya, paprika, pennyroyal, peppermint (Mentha piperita), pimento, potato peel, primrose, quercetin, quince, red clover, resveratrol, Rhizoma gastrodiae, Rhodiola, rooibos (red or green), rosehip (Rosa canina), rosemary, saffron, sage, Saint John's Wort, sandalwood, salvia (Salvia officinalis), savory, saw palmetto, Sceletium tortuosum, Schisandra, Silybum marianum, Skullcap, spearmint, Spikenard, spirulina, slippery elm bark, sorghum bran hi-tannin, sorghum grain hi-tannin, spearmint (Mentha spicata), Spirulina, star anise, sumac bran, tarragon, thyme, tisanes, turmeric, Turnera aphrodisiaca, uva ursi, valerian, vanilla, Viola odorata, wild yam root, wintergreen, withania somnifera, yacon root, yellow dock, yerba mate, and yerba santa.

### Stimulant

In some embodiments, the active ingredient comprises one or more stimulants. As used herein, the term “stimulant” refers to a material that increases activity of the central nervous system and/or the body, for example, enhancing focus, cognition, vigor, mood, alertness, and the like. Non-limiting examples of stimulants include caffeine, theacrine, theobromine, and theophylline. Theacrine (1,3,7,9-tetramethyluric acid) is a purine alkaloid which is structurally related to caffeine, and possesses stimulant, analgesic, and anti-inflammatory effects. Present stimulants may be natural, naturally derived, or wholly synthetic. For example, certain botanical materials (guarana, tea, coffee, cocoa, and the like) may possess a stimulant effect by virtue of the presence of e.g., caffeine or related alkaloids, and accordingly are “natural” stimulants. By “naturally derived” is meant the stimulant (e.g., caffeine, theacrine) is in a purified form, outside its natural (e.g., botanical) matrix. For example, caffeine can be obtained by extraction and purification from botanical sources (e.g., tea). By “wholly synthetic”, it is meant that the stimulant has been obtained by chemical synthesis. In some embodiments, the active ingredient comprises caffeine. In some embodiments, the active ingredient is caffeine. In some embodiments, the caffeine is present in an encapsulated form. On example of an encapsulated caffeine is Vitashure®, available from Balchem Corp., 52 Sunrise Park Road, New Hampton, NY, 10958.

When present, a stimulant or combination of stimulants (e.g., caffeine, theacrine, and combinations thereof) is typically at a concentration of from about 0.1% w/w to about 15% by weight, such as, e.g., from about from about 0.1% w/w, about 0.2%, about 0.3%, about 0.4%, about 0.5% about 0.6%, about 0.7%, about 0.8%, or about 0.9%, to about 1%, about 2%, about 3%, about 4%, about 5%, about 6%, about 7%, about 8%, about 9%, about 10%, about 11%, about 12%, about 13%, about 14%, or about 15% by weight, based on the total weight of the composition.

### Amino Acid

In some embodiments, the active ingredient comprises an amino acid. As used herein, the term “amino acid” refers to an organic compound that contains amine (—NH₂) and carboxyl (—COOH) or sulfonic acid (SO₃H) functional groups, along with a side chain (R group), which is specific to each amino acid. Amino acids may be proteinogenic or non-proteinogenic. By “proteinogenic” is meant that the amino acid is one of the twenty naturally occurring amino acids found in proteins. The proteinogenic amino acids include alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, and valine. By “non-proteinogenic” is meant that either the amino acid is not found naturally in protein, or is not directly produced by cellular machinery (e.g., is the product of post-translational modification). Non-limiting examples of non-proteinogenic amino acids include gamma-aminobutyric acid (GABA), taurine (2-aminoethanesulfonic acid), theanine (L-y-glutamylethylamide), hydroxyproline, and beta-alanine.

When present, an amino acid or combination of amino acids (e.g., taurine, theanine, and combinations thereof) is typically at a concentration of from about 0.1% w/w to about 15% by weight, such as, e.g., from about from about 0.1% w/w, about 0.2%, about 0.3%, about 0.4%, about 0.5% about 0.6%, about 0.7%, about 0.8%, or about 0.9%, to about 1%, about 2%, about 3%, about 4%, about 5%, about 6%, about 7%, about 8%, about 9%, about 10%, about 11%, about 12%, about 13%, about 14%, or about 15% by weight, based on the total weight of the composition.

Vitamin and/or Mineral

In some embodiments, the active ingredient comprises a vitamin or combination of vitamins. As used herein, the term “vitamin” refers to an organic molecule (or related set of molecules) that is an essential micronutrient needed for the proper functioning of metabolism in a mammal. There are thirteen vitamins required by human metabolism, which are: vitamin A (as all-trans-retinol, all-trans-retinyl-esters, as well as all-trans-beta-carotene and other provitamin A carotenoids), vitamin B1 (thiamine), vitamin B2 (riboflavin), vitamin B3 (niacin), vitamin B5 (pantothenic acid), vitamin B6 (pyridoxine), vitamin B7 (biotin), vitamin B9 (folic acid or folate), vitamin B12 (cobalamins), vitamin C (ascorbic acid), vitamin D (calciferols), vitamin E (tocopherols and tocotrienols), and vitamin K (quinones). In some embodiments, the active ingredient comprises vitamin C. In some embodiments, the active ingredient is a combination of vitamin C, caffeine, and taurine. In some embodiments, the active ingredient comprises one or more of vitamin B6 and B12. In some embodiments, the active ingredient comprises theanine and one or more of vitamin B6 and B12.

When present, a vitamin or combination of vitamins (e.g., vitamin B6, vitamin B12, vitamin E, vitamin C, or a combination thereof) is typically at a concentration of from about 0.01% w/w to about 1% by weight, such as, e.g., from about 0.01%, about 0.02%, about 0.03%, about 0.04%, about 0.05%, about 0.06%, about 0.07%, about 0.08%, about 0.09%, or about 0.1% w/w, to about 0.2%, about 0.3%, about 0.4%, about 0.5% about 0.6%, about 0.7%, about 0.8%, about 0.9%, or about 1% by weight, based on the total weight of the composition.

In some embodiments, the active ingredient comprises vitamin A. In some embodiments, the vitamin A is encapsulated. In some embodiments, the vitamin is vitamin B6, vitamin B12, vitamin E, vitamin C, or a combination thereof.

In some embodiments, the active ingredient comprises a mineral. As used herein, the term “mineral” refers to an inorganic molecule (or related set of molecules) that is an essential micronutrient needed for the proper functioning of various systems in a mammal. Non-limiting examples of minerals include iron, zinc, copper, selenium, chromium, cobalt, manganese, calcium, phosphorus, sulfur, magnesium, and the like. In some embodiments, the active ingredient comprises iron. Suitable sources of iron include, but are not limited to, ferrous salts such as ferrous sulfate and ferrous gluconate. In some embodiments, the iron is encapsulated.

### Cannabinoids

In some embodiments, the active ingredient comprises one or more cannabinoids. As used herein, the term “cannabinoid” refers to a class of diverse natural or synthetic chemical compounds that acts on cannabinoid receptors (i.e., CB1 and CB2) in cells that alter neurotransmitter release in the brain. Cannabinoids are cyclic molecules exhibiting particular properties such as the ability to easily cross the blood-brain barrier. Cannabinoids may be naturally occurring (Phytocannabinoids) from plants such as cannabis, (endocannabinoids) from animals, or artificially manufactured (synthetic cannabinoids). Cannabis species express at least 85 different phytocannabinoids, and these may be divided into subclasses, including cannabigerols, cannabichromenes, cannabidiols, tetrahydrocannabinols, cannabinols and cannabinodiols, and other cannabinoids, such as cannabigerol (CBG), cannabichromene (CBC), cannabidiol (CBD), tetrahydrocannabinol (THC), cannabinol (CBN) and cannabinodiol (CBDL), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM), cannabinerolic acid, cannabidiolic acid (CBDA), cannabinol propyl variant (CBNV), cannabitriol (CBO), tetrahydrocannabmolic acid (THCA), and tetrahydrocannabivarinic acid (THCV A).

In some embodiments, the cannabinoid is selected from the group consisting of cannabigerol (CBG), cannabichromene (CBC), cannabidiol (CBD), tetrahydrocannabinol (THC), cannabinol (CBN) and cannabinodiol (CBDL), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM), cannabinerolic acid, cannabidiolic acid (CBDA), Cannabinol propyl variant (CBNV), cannabitriol (CBO), tetrahydrocannabinolic acid (THCA), tetrahydrocannabivarinic acid (THCV A), and mixtures thereof. In some embodiments, the cannabinoid comprises at least tetrahydrocannabinol (THC). In some embodiments, the cannabinoid is tetrahydrocannabinol (THC). In some embodiments, the cannabinoid comprises at least cannabidiol (CBD). In some embodiments, the cannabinoid is cannabidiol (CBD). In some embodiments, the CBD is synthetic CBD.

In some embodiments, the cannabinoid (e.g., CBD) is added to the composition in the form of an isolate. An isolate is an extract from a plant, such as cannabis, where the active material of interest (in this case the cannabinoid, such as CBD) is present in a high degree of purity, for example greater than 95%, greater than 96%, greater than 97%, greater than 98%, or around 99% purity.

In some embodiments, the cannabinoid is an isolate of CBD in a high degree of purity, and the amount of any other cannabinoid in the composition is no greater than about 1% by weight of the composition, such as no greater than about 0.5% by weight of the composition, such as no greater than about 0.1% by weight of the composition, such as no greater than about 0.01% by weight of the composition.

The choice of cannabinoid and the particular percentages thereof which may be present within the disclosed composition will vary depending upon the desired flavor, texture, and other characteristics of the composition.

In some embodiments, the cannabinoid (such as CBD) is present in the composition in a concentration of at least about 0.001% by weight of the composition, such as in a range from about 0.001% to about 2% by weight of the composition. In some embodiments, the cannabinoid (such as CBD) is present in the composition in a concentration of from about 0.1% to about 1.5% by weight, based on the total weight of the composition. In some embodiments, the cannabinoid (such as CBD) is present in a concentration from about 0.4% to about 1.5% by weight, based on the total weight of the oral composition.

Alternatively, or in addition to the cannabinoid, the active ingredient may include a cannabimimetic, which is a class of compounds derived from plants other than cannabis that have biological effects on the endocannabinoid system similar to cannabinoids. Examples include yangonin, alpha-amyrin or beta-amyrin (also classified as terpenes), cyanidin, curcumin (tumeric), catechin, quercetin, salvinorin A, N-acylethanolamines, and N-alkylamide lipids. Such compounds can be used in the same amounts and ratios noted herein for cannabinoids.

### Terpene

Active ingredients suitable for use in the present disclosure can also be classified as terpenes, many of which are associated with biological effects, such as calming effects. Terpenes are understood to have the general formula of (C₅H₈)ₙ and include monoterpenes, sesquiterpenes, and diterpenes. Terpenes can be acyclic, monocyclic or bicyclic in structure. Some terpenes provide an entourage effect when used in combination with cannabinoids or cannabimimetics. Examples include beta-caryophyllene, linalool, limonene, beta-citronellol, linalyl acetate, pinene (alpha or beta), geraniol, carvone, eucalyptol, menthone, iso-menthone, piperitone, myrcene, beta-bourbonene, and germacrene, which may be used singly or in combination.

In some embodiments, the terpene is a terpene derivable from a phytocannabinoid producing plant, such as a plant from the stain of the Cannabis sativa species, such as hemp. Suitable terpenes in this regard include so-called “C10” terpenes, which are those terpenes comprising 10 carbon atoms, and so-called “C15” terpenes, which are those terpenes comprising 15 carbon atoms. In some embodiments, the active ingredient comprises more than one terpene. For example, the active ingredient may comprise one, two, three, four, five, six, seven, eight, nine, ten or more terpenes as defined herein. In some embodiments, the terpene is selected from pinene (alpha and beta), geraniol, linalool, limonene, carvone, eucalyptol, menthone, iso-menthone, piperitone, myrcene, beta-bourbonene, germacrene and mixtures thereof.

### Antioxidant

In some embodiments, the active ingredient comprises one or more antioxidants. As used herein, the term “antioxidant” refers to a substance which prevents or suppresses oxidation by terminating free radical reactions, and may delay or prevent some types of cellular damage. Antioxidants may be naturally occurring or synthetic. Naturally occurring antioxidants include those found in foods and botanical materials. Non-limiting examples of antioxidants include certain botanical materials, vitamins, polyphenols, and phenol derivatives.

Examples of botanical materials which are associated with antioxidant characteristics include without limitation acai berry, alfalfa, allspice, annatto seed, apricot oil, basil, bee balm, wild bergamot, black pepper, blueberries, borage seed oil, bugleweed, cacao, calamus root, catnip, catuaba, cayenne pepper, chaga mushroom, chervil, cinnamon, dark chocolate, potato peel, grape seed, Ginseng, Gingko biloba, Saint John's Wort, saw palmetto, green tea, black tea, black cohosh, cayenne, chamomile, cloves, cocoa powder, cranberry, dandelion, grapefruit, honeybush, echinacea, garlic, evening primrose, feverfew, ginger, goldenseal, hawthorn, hibiscus flower, jiaogulan, kava, lavender, licorice, marjoram, milk thistle, mints (menthe), oolong tea, beet root, orange, oregano, papaya, pennyroyal, peppermint, red clover, rooibos (red or green), rosehip, rosemary, sage, clary sage, savory, spearmint, spirulina, slippery elm bark, sorghum bran hi-tannin, sorghum grain hi-tannin, sumac bran, comfrey leaf and root, goji berries, gutu kola, thyme, turmeric, uva ursi, valerian, wild yam root, wintergreen, yacon root, yellow dock, yerba mate, yerba santa, bacopa monniera, withania somnifera, Lion's mane, and Silybum marianum. Such botanical materials may be provided in fresh or dry form, essential oils, or may be in the form of an extracts. The botanical materials (as well as their extracts) often include compounds from various classes known to provide antioxidant effects, such as minerals, vitamins, isoflavones, phytoesterols, allyl sulfides, dithiolthiones, isothiocyanates, indoles, lignans, flavonoids, polyphenols, and carotenoids. Examples of compounds found in botanical extracts or oils include ascorbic acid, peanut endocarb, resveratrol, sulforaphane, beta-carotene, lycopene, lutein, co-enzyme Q, carnitine, quercetin, kaempferol, and the like. See, e.g., Santhosh et al., Phytomedicine, 12 (2005) 216-220, which is incorporated herein by reference.

Non-limiting examples of other suitable antioxidants include citric acid, Vitamin E or a derivative thereof, a tocopherol, epicatechol, epigallocatechol, epigallocatechol gallate, erythorbic acid, sodium erythorbate, 4-hexylresorcinol, theaflavin, theaflavin monogallate A or B, theaflavin digallate, phenolic acids, glycosides, quercitrin, isoquercitrin, hyperoside, polyphenols, catechols, resveratrols, oleuropein, butylated hydroxyanisole (BHA), butylated hydroxytoluene (BHT), tertiary butylhydroquinone (TBHQ), and combinations thereof.

When present, an antioxidant is typically at a concentration of from about 0.001% w/w to about 10% by weight, such as, e.g., from about from about 0.001%, about 0.005%, about 0.01% w/w, about 0.05%, about 0.1%, or about 0.5%, to about 1%, about 2%, about 3%, about 4%, about 5%, about 6%, about 7%, about 8%, about 9%, or about 10%, based on the total weight of the composition.

### Nicotine Component

By “nicotine component” is meant any suitable form of nicotine (e.g., free base, salt, or ion pair) for providing oral absorption of at least a portion of the nicotine present. Nicotine is released from the composition and absorbed through the oral mucosa, thereby entering the blood stream, where it is circulated systemically. In some embodiments, the nicotine component can comprise two or more different nicotine components.

The source of the nicotine may vary, and may be natural or synthetic. Nicotine may be tobacco-derived (e.g., a tobacco extract) or non-tobacco derived (e.g., synthetic or otherwise obtained). The nicotine, in some embodiments, is naturally occurring and obtained as an extract from a Nicotiana species (e.g., tobacco). The nicotine can be, for example, in the form of a highly purified tobacco extract. Various methods are known for the isolation and purification of nicotine from tobacco (including, but not limited to, extraction from tobacco with water; extraction from tobacco with organic solvents; steam distillation from tobacco; or pyrolytic degradation of tobacco and distillation of nicotine therefrom). For exemplary extraction methods, see for example, U.S. Pat. Nos. 2,822,306 and 4,153,063 to Roselius et al. and US Pat. App. Pub. No. 2008/0302377 to Kauryzbaev et al., which are incorporated herein by reference. In some embodiments, nicotine may be obtained from another source (e.g., another type of plant).

In some embodiments, nicotine may be synthetically made. The method by which synthetic nicotine used in some embodiments of the compositions and products described herein is synthesized can vary and is not particularly limited. Various methods for the preparation of nicotine are known. See, e.g., Florence L. Wagner et al., 63 Tetrahedron 8065 (2007); U.S. Pat. No. 10,913,962 to McCague et al.; and U.S. Patent App. Pub. No. 2020/0331884 to Weber et al., which are incorporated herein by reference in their entireties.

The nicotine can have the enantiomeric form S(−)-nicotine, R(+)-nicotine, or a mixture of S(−)-nicotine and R(+)-nicotine. The nicotine can be in the form of S(−)-nicotine (e.g., in a form that is virtually all S(−)-nicotine) or a racemic mixture composed primarily or predominantly of S(−)-nicotine (e.g., a mixture composed of about 95 weight parts S(−)-nicotine and about 5 weight parts R(+)-nicotine). The nicotine is typically employed in virtually pure form or in an essentially pure form, such as nicotine having a purity of greater than about 95 percent, greater than about 98 percent, or greater than about 99 percent, on a weight basis.

Typically, the nicotine component is selected from the group consisting of nicotine free base, nicotine as an ion pair, and a nicotine salt. In some embodiments, at least a portion of the nicotine is in its free base form. In some embodiments, at least a portion of the nicotine is present as a nicotine salt, or at least a portion of the nicotine is present as an ion pair with at least a portion of the organic acid or the conjugate base thereof, as described further herein below.

Alternatively, all or a portion of the nicotine component is a nicotine-polymer complex. Such complexes, in some embodiments, comprise a polymeric resin (e.g., a polymeric ion-exchange resin, e.g., a polymeric cation exchange resin) to which nicotine is bound. One example of such a resin is a polymethacrilic acid, such as Amberlite IRP64, Purolite C115HMR, or Doshion P551. See, for example, U.S. Pat. No. 3,901,248 to Lichtneckert et al., which is incorporated herein by reference. Another example is a nicotine-polyacrylic carbomer complex, such as Carbopol 974P. In some embodiments, nicotine may be present in the form of a nicotine polyacrylic complex. One example of a suitable nicotine-polymer complex is nicotine polacrilex, which comprises nicotine bound to a resin prepared from methacrylic acid and divinyl benzene. Nicotine polacrilex is available in varying nicotine percentages, e.g., 18% to 20% nicotine; although not limited thereto, nicotine polacrilex generally comprises not less than 95% of the labeled amount of nicotine, calculated on an anhydrous basis.

In some embodiments, inclusion of a nicotine component in the form of a nicotine-polymer complex can lead to improved shelf-life stability and slower release of the nicotine. In some embodiments, inclusion of a nicotine component in the form of a nicotine-polymer complex can lead to less burn in the oral cavity or throat during use. The amount of nicotine provided by the nicotine-polymer complex can vary from about 5%, about 10%, about 20%, about 30%, about 40%, about 50%, or about 60% to about 40%, about 50%, about 60%, about 70%, about 80%, about 90%, about 95%, or 100%, based on the total weight of nicotine provided from all nicotine components within a given composition. Certain, non-limiting example amounts of nicotine-polymer complex (including resin and nicotine) incorporated within a given composition can range, e.g., from about 0.5% by weight to about 15% by weight, e.g., about 1% by weight to about 10% by weight, e.g., about 2% to about 8% by weight, based on the total weight of a composition/mixture to be included within a pouched product.

Typically, the nicotine component (calculated as the free base) is present in a concentration of at least about 0.001% by weight of the composition, such as in a range from about 0.001% to about 10%. In some embodiments, the nicotine component is present in a concentration from about 0.1% w/w to about 10% by weight, such as, e.g., from about from about 0.1% w/w, about 0.2%, about 0.3%, about 0.4%, about 0.5% about 0.6%, about 0.7%, about 0.8%, or about 0.9%, to about 1%, about 2%, about 3%, about 4%, about 5%, about 6%, about 7%, about 8%, about 9%, or about 10% by weight, calculated as the free base and based on the total weight of the composition. In some embodiments, the nicotine component is present in a concentration from about 0.1% w/w to about 3% by weight, such as, e.g., from about from about 0.1% w/w to about 2.5%, from about 0.1% to about 2.0%, from about 0.1% to about 1.5%, or from about 0.1% to about 1% by weight, calculated as the free base and based on the total weight of the composition.

In some embodiments, the products or compositions of the disclosure can be characterized as free of any nicotine component (e.g., any embodiment as disclosed herein may be completely or substantially free of any nicotine component). By “substantially free” is meant that no nicotine has been intentionally added, beyond trace amounts that may be naturally present in e.g., a botanical material. For example, some embodiments can be characterized as having less than 0.001% by weight of nicotine, or less than 0.0001%, or even 0% by weight of nicotine, calculated as the free base.

### Pharmaceutical Ingredient

In some embodiments, the active ingredient comprises an active pharmaceutical ingredient (API). The API can be any known agent adapted for therapeutic, prophylactic, or diagnostic use. These can include, for example, synthetic organic compounds, proteins and peptides, polysaccharides and other sugars, lipids, phospholipids, inorganic compounds (e.g., magnesium, selenium, zinc, nitrate), neurotransmitters or precursors thereof (e.g., serotonin, 5-hydroxytryptophan, oxitriptan, acetylcholine, dopamine, melatonin), and nucleic acid sequences, having therapeutic, prophylactic, or diagnostic activity. Non-limiting examples of APIs include analgesics and antipyretics (e.g., acetylsalicylic acid, acetaminophen, 3-(4-isobutylphenyl) propanoic acid), phosphatidylserine, myoinositol, docosahexaenoic acid (DHA, Omega-3), arachidonic acid (AA, Omega-6), S-adenosylmethionine (SAM), beta-hydroxy-beta-methylbutyrate (HMB), citicoline (cytidine-5′-diphosphate-choline), and cotinine.

When present, the amount of API may vary. For example, when present, an API is typically at a concentration of from about 0.001% w/w to about 10% by weight, such as, e.g., from about from about 0.01%, about 0.02%, about 0.03%, about 0.04%, about 0.05%, about 0.06%, about 0.07%, about 0.08%, about 0.09%, about 0.1% w/w, about 0.2%, about 0.3%, about 0.4%, about 0.5% about 0.6%, about 0.7%, about 0.8%, about 0.9%, or about 1%, to about 2%, about 3%, about 4%, about 5%, about 6%, about 7%, about 8%, about 9%, or about 10% by weight, based on the total weight of the composition.

### Encapsulation and Stabilization of Active Ingredients

In some embodiments, an active ingredient as described herein may be sensitive to degradation (e.g., oxidative, photolytic, thermal, evaporative) during processing or upon storage of the composition. In such embodiments, the active ingredient (such as caffeine, vitamin A, and iron (Fe)) may be encapsulated, or the composition otherwise modified with suitable components (such as fillers, binders, and the like), to provide enhanced stability to the active ingredient. For example, binders such as functional celluloses (e.g., cellulose ethers including, but not limited to, hydroxypropyl cellulose) or alginate-based materials (e.g., cross linked alginate) may be employed to enhance stability of such actives toward degradation, or to provide extended and/or separate delivery of active ingredients. Additionally, encapsulated actives may need to be paired with an excipient in the composition to increase their solubility and/or bioavailability. Non-limiting examples of suitable excipients include beta-carotene, lycopene, Vitamin D, Vitamin E, Co-enzyme Q10, Vitamin K, and curcumin.

In some embodiments, in order to provide a desired concentration of the active ingredient by weight, an initial quantity of the active ingredient may be increased to compensate for a gradual degradative loss. Accordingly, larger initial amounts than those disclosed herein are contemplated by the present disclosure.

### Water

The water content of the composition, prior to use by a consumer of the composition, may vary according to the desired properties. Typically, the composition is less than about 60 percent by weight of water, and generally is from about 1 to about 60% by weight of water, for example, from about 5 to about 55, about 10 to about 50, about 20 to about 45, or about 25 to about 40 percent water by weight. In embodiments where the encapsulated pH adjusting agent is adapted for release in the presence of moisture, lower moisture levels may be desirable. In some embodiments, the composition contains less than about 20 percent by weight of water, such as about 15 weight percent or less, about 12 weight percent or less, about 10 weight percent or less (e.g., about 1 to about 20 weight percent or about 5 to about 15 weight percent water, based on the total weight of the composition).

### Organic Acid

In some embodiments, the composition as disclosed herein comprises one or more organic acids. For example, addition of an organic acid can be used to lower the initial pH of the composition and/or can be used as an ion pairing agent for nicotine. As used herein, the term “organic acid” refers to an organic (i.e., carbon-based) compound that is characterized by acidic properties. Typically, organic acids are relatively weak acids (i.e., they do not dissociate completely in the presence of water), such as carboxylic acids (—CO₂H) or sulfonic acids (—SO₂OH). As used herein, reference to organic acid means an organic acid that is intentionally added. In this regard, an organic acid may be intentionally added as a specific composition ingredient as opposed to merely being inherently present as a component of another composition ingredient (e.g., the small amount of organic acid which may inherently be present in a composition ingredient, such as a tobacco material).

Suitable organic acids will typically have a range of lipophilicities (i.e., a polarity giving an appropriate balance of water and organic solubility). Typically, lipophilicities of suitable organic acids, as indicated by log P, will vary between about 1 and about 12 (more soluble in octanol than in water). In some embodiments, the organic acid has a log P value from about 1 to about 12, e.g., from about 1.0. about 1.5, about 2.0, about 2.5, about 3.0, about 3.5, about 4.0, about 4.5, about 5.0, about 5.5, about 6.0, about 6.5, about 7.0, about 7.5, or about 8.0, to about 8.5, about 9.0, about 9.5, about 10.0, about 10.5, about 11.0, about 11.5, or about 12.0.

Without wishing to be bound by theory, it is believed that moderately lipophilic organic acids (e.g., log P of from about 1.4 to about 4.5) produce ion pairs with nicotine which are of a polarity providing good octanol-water partitioning of the ion pair, and hence partitioning of nicotine, into octanol versus water. As discussed above, such partitioning into octanol is predictive of favorable oral availability.

In specific embodiments, the organic acid has a log P value from about 3.0 to about 8.0, about 10.0, or even 12.0. In some embodiments, the presence of certain solvents or solubilizing agents (e.g., inclusion in the composition of glycerin or propylene glycol) may be beneficial in solubilizing organic acids and the corresponding salts or ion pairs thereof with the basic amine for highly lipophilic organic acids (e.g., higher than about 4.5).

In some embodiments, the organic acid is a carboxylic acid or a sulfonic acid. The carboxylic acid or sulfonic acid functional group may be attached to any alkyl, cycloalkyl, heterocycloalkyl, aryl, or heteroaryl group having, for example, from one to twenty carbon atoms (C₁-C₂₀). In some embodiments, the organic acid is an alkyl, cycloalkyl, heterocycloalkyl, aryl, or heteroaryl carboxylic or sulfonic acid.

As used herein, “alkyl” refers to any straight chain or branched chain hydrocarbon. The alkyl group may be saturated (i.e., having all sp³ carbon atoms), or may be unsaturated (i.e., having at least one site of unsaturation). As used herein, the term “unsaturated” refers to the presence of a carbon-carbon, sp² double bond in one or more positions within the alkyl group. Unsaturated alkyl groups may be mono- or polyunsaturated. Representative straight chain alkyl groups include, but are not limited to, methyl, ethyl, n-propyl, n-butyl, n-pentyl, and n-hexyl. Branched chain alkyl groups include, but are not limited to, isopropyl, sec-butyl, isobutyl, tert-butyl, isopentyl, and 2-methylbutyl. Representative unsaturated alkyl groups include, but are not limited to, ethylene or vinyl, allyl, 1-butenyl, 2-butenyl, isobutylenyl, 1-pentenyl, 2-pentenyl, 3-methyl-1-butenyl, 2-methyl-2-butenyl, 2,3-dimethyl-2-butenyl, and the like. An alkyl group can be unsubstituted or substituted.

“Cycloalkyl” as used herein refers to a carbocyclic group, which may be mono- or bicyclic. Cycloalkyl groups include rings having 3 to 7 carbon atoms as a monocycle or 7 to 12 carbon atoms as a bicycle. Examples of monocyclic cycloalkyl groups include cyclopropyl, cyclobutyl, cyclopentyl, cyclohexyl, cycloheptyl, and cyclooctyl. A cycloalkyl group can be unsubstituted or substituted, and may include one or more sites of unsaturation (e.g., cyclopentenyl or cyclohexenyl).

The term “aryl” as used herein refers to a carbocyclic aromatic group. Examples of aryl groups include, but are not limited to, phenyl and naphthyl. An aryl group can be unsubstituted or substituted.

“Heteroaryl” and “heterocycloalkyl” as used herein refer to an aromatic or non-aromatic ring system, respectively, in which one or more ring atoms is a heteroatom, e.g. nitrogen, oxygen, and sulfur. The heteroaryl or heterocycloalkyl group comprises up to 20 carbon atoms and from 1 to 3 heteroatoms selected from N, O, and S. A heteroaryl or heterocycloalkyl may be a monocycle having 3 to 7 ring members (for example, 2 to 6 carbon atoms and 1 to 3 heteroatoms selected from N, O, and S) or a bicycle having 7 to 10 ring members (for example, 4 to 9 carbon atoms and 1 to 3 heteroatoms selected from N, O, and S), for example: a bicyclo[4,5], [5,5], [5,6], or [6,6] system. Examples of heteroaryl groups include by way of example and not limitation, pyridyl, thiazolyl, tetrahydrothiophenyl, pyrimidinyl, furanyl, thienyl, pyrrolyl, pyrazolyl, imidazolyl, tetrazolyl, benzofuranyl, thianaphthalenyl, indolyl, indolenyl, quinolinyl, isoquinolinyl, benzimidazolyl, isoxazolyl, pyrazinyl, pyridazinyl, indolizinyl, isoindolyl, 3H-indolyl, 1H-indazolyl, purinyl, 4H-quinolizinyl, phthalazinyl, naphthyridinyl, quinoxalinyl, quinazolinyl, cinnolinyl, pteridinyl, 4aH-carbazolyl, carbazolyl, phenanthridinyl, acridinyl, pyrimidinyl, phenanthrolinyl, phenazinyl, phenothiazinyl, furazanyl, phenoxazinyl, isochromanyl, chromanyl, imidazolidinyl, imidazolinyl, pyrazolidinyl, pyrazolinyl, benzotriazolyl, benzisoxazolyl, and isatinoyl. Examples of heterocycloalkyls include by way of example and not limitation, dihydroypyridyl, tetrahydropyridyl (piperidyl), tetrahydrothiophenyl, piperidinyl, 4-piperidonyl, pyrrolidinyl, 2-pyrrolidonyl, tetrahydrofuranyl, tetrahydropyranyl, bis-tetrahydropyranyl, tetrahydroquinolinyl, tetrahydroisoquinolinyl, decahydroquinolinyl, octahydroisoquinolinyl, piperazinyl, quinuclidinyl, and morpholinyl. Heteroaryl and heterocycloalkyl groups can be unsubstituted or substituted.

“Substituted” as used herein and as applied to any of the above alkyl, aryl, cycloalkyl, heteroaryl, heterocyclyl, means that one or more hydrogen atoms are each independently replaced with a substituent. Typical substituents include, but are not limited to, —Cl, Br, F, alkyl, —OH, —OCH₃, NH₂, —NHCH₃, —N(CH₃)₂, —CN, —NC(═O)CH₃, —C(—O)—, —C(═O)NH₂, and —C(═O) N(CH₃)₂. Wherever a group is described as “optionally substituted,” that group can be substituted with one or more of the above substituents, independently selected for each occasion. In some embodiments, the substituent may be one or more methyl groups or one or more hydroxyl groups.

In some embodiments, the organic acid is an alkyl carboxylic acid. Non-limiting examples of alkyl carboxylic acids include formic acid, acetic acid, propionic acid, butyric acid, valeric acid, caproic acid, heptanoic acid, octanoic acid, nonanoic acid, decanoic acid, undecanoic acid, dodecanoic acid, stearic acid, oleic acid, linoleic acid, linolenic acid, and the like.

In some embodiments, the organic acid is an alkyl sulfonic acid. Non-limiting examples of alkyl sulfonic acids include propanesulfonic acid, heptanesulfonic acid, and octanesulfonic acid.

In some embodiments, the alkyl carboxylic or sulfonic acid is substituted with one or more hydroxyl groups. Non-limiting examples include glycolic acid, 4-hydroxybutyric acid, and lactic acid.

In some embodiments, an organic acid may include more than one carboxylic acid group or more than one sulfonic acid group (e.g., two, three, or more carboxylic acid groups). Non-limiting examples include oxalic acid, fumaric acid, maleic acid, and glutaric acid. In organic acids containing multiple carboxylic acids (e.g., from two to four carboxylic acid groups), one or more of the carboxylic acid groups may be esterified. Non-limiting examples include succinic acid monoethyl ester, monomethyl fumarate, monomethyl or dimethyl citrate, and the like.

In some embodiments, the organic acid may include more than one carboxylic acid group and one or more hydroxyl groups. Non-limiting examples of such acids include tartaric acid, citric acid, and the like.

In some embodiments, the organic acid is an aryl carboxylic acid or an aryl sulfonic acid. Non-limiting examples of aryl carboxylic and sulfonic acids include benzoic acid, toluic acids, salicylic acid, benzenesulfonic acid, and p-toluenesulfonic acid.

Further non-limiting examples of organic acids which may be useful in some embodiments include 2-(4-isobutylphenyl) propanoic acid, 2,2-dichloroacetic acid, 2-hydroxyethanesulfonic acid, 2-oxoglutaric acid, 4-acetamidobenzoic acid, 4-aminosalicylic acid, adipic acid, ascorbic acid (L), aspartic acid (L), alpha-methylbutyric acid, camphoric acid (+), camphor-10-sulfonic acid (+), cinnamic acid, cyclamic acid, dodecylsulfuric acid, ethane-1,2-disulfonic acid, ethanesulfonic acid, furoic acid, galactaric acid, gentisic acid, glucoheptonic acid, gluconic acid, glucuronic acid, glutamic acid, glycerophosphoric acid, glycolic acid, hippuric acid, isobutyric acid, isovaleric acid, lactobionic acid, lauric acid, levulinic acid, malic acid, malonic acid, mandelic acid, methanesulfonic acid, naphthalene-1,5-disulfonic acid, naphthalene-2-sulfonic acid, oleic acid, palmitic acid, pamoic acid, phenylacetic acid, pyroglutamic acid, pyruvic acid, sebacic acid, stearic acid, and undecylenic acid.

Examples of suitable acids include, but are not limited to, the organic acids in Table 1.

TABLE 1
Non-limiting examples of suitable organic acids

| Acid Name | log(P)* |
|---|---|
| benzoic acid | 1.9 |
| phenylacetic | 1.4 |
| p-toluic acid | 2.3 |
| ethyl benzoic acid | 2.9 |
| isopropyl benzoic acid | 3.5 |
| 4-phenylbutyric | 2.4 |
| 2-(4-Isobutylphenyl)propanoic acid | 3.5 |
| 2-napthoxyacetic acid | 2.5 |
| napthylacetic acid | 2.7 |
| heptanoic acid | 2.5 |
| octanoic acid | 3.05 |
| nonanoic acid | 3.5 |
| decanoic acid | 4.09 |
| 9-deceneoic acid | 3.3 |
| 2-deceneoic acid | 3.8 |
| 10-undecenoic acid | 3.9 |
| dodecandioic acid | 3.2 |
| dodecanoic acid | 4.6 |
| myristic acid | 5.3 |
| palmitic acid | 6.4 |
| stearic acid | 7.6 |
| cyclohexanebutanoic acid | 3.4 |
| 1-heptanesulfonic acid | 2.0 |
| 1-octanesulfonic acid | 2.5 |
| 1-nonanesulfonic acid | 3.1 |
| monooctyl succinate | 2.8 |
| tocopherol succinate | 10.2 |
| monomenthyl succinate | 3 |
| monomenthyl glutarate | 3.4 |
| norbixin ((2E,4E,6E,8E,10E,12E,14E,16E,18E)-4,8,13,17- | 7.2 |
| tetramethylicosa-2,4,6,8,10,12,14,16,18-nonaenedioic | |
| acid) | |
| bixin ((2E,4E,6E,8E,10E,12E,14E,16Z,18E)-20-methoxy- | 7.5 |
| 4,8,13,17-tetramethyl-20-oxoicosa-2,4,6,8,10,12,14,16,18- | |
| nonaenoic acid) | |

*Values obtained from PubChem or calculated

The selection of organic acid may further depend on additional properties in addition to consideration of the log P value. For example, an organic acid should be one recognized as safe for human consumption, and which has acceptable flavor, odor, volatility, stability, and the like. Determination of appropriate organic acids is within the purview of one of skill in the art.

In some embodiments, the organic acid is a mono ester of a dicarboxylic acid or a poly-carboxylic acid. In some embodiments, the dicarboxylic acid is malonic acid, succinic acid, glutaric acid, adipic acid, fumaric acid, maleic acid, or a combination thereof. In some embodiments, the dicarboxylic acid is succinic acid, glutaric acid, fumaric acid, maleic acid, or a combination thereof. In some embodiments, the dicarboxylic acid is succinic acid, glutaric acid, or a combination thereof.

In some embodiments, the alcohol forming the mono ester of the dicarboxylic acid is a lipophilic alcohol. Examples of suitable lipophilic alcohols include, but are not limited to, octanol, menthol, and tocopherol. In some embodiments, the organic acid is an octyl mono ester of a dicarboxylic acid, such as monooctyl succinate, monooctyl fumarate, or the like. In some embodiments, the organic acid is a monomenthyl ester of a dicarboxylic acid. Certain menthyl esters may be desirable in oral compositions as described herein by virtue of the cooling sensation they may provide upon use of the product comprising the composition. In some embodiments, the organic acid is monomenthyl succinate, monomenthyl fumarate, monomenthyl glutarate, or a combination thereof. In some embodiments, the organic acid is a monotocopheryl ester of a dicarboxylic acid. Certain tocopheryl esters may be desirable in oral compositions as described herein by virtue of the antioxidant effects they may provide. In some embodiments, the organic acid is tocopheryl succinate, tocopheryl fumarate, tocopheryl glutarate, or a combination thereof.

In some embodiments, the organic acid is a carotenoid derivative having one or more carboxylic acids. Carotenoids are tetraterpenes, meaning that they are produced from 8 isoprene molecules and contain 40 carbon atoms. Accordingly, they are usually lipophilic due to the presence of long unsaturated aliphatic chains, and are generally yellow, orange, or red in color. Certain carotenoid derivatives can be advantageous in oral compositions by virtue of providing both ion pairing and serving as a colorant in the composition. In some embodiments, the organic acid is 2E,4E,6E,8E,10E,12E,14E,16Z,18E)-20-methoxy-4,8,13,17-tetramethyl-20-oxoicosa-2,4,6,8,10,12, 14, 16, 18-nonaenoic acid (bixin) or an isomer thereof. Bixin is an apocarotenoid found in annatto seeds from the achiote tree (Bixa orellana), and is the naturally occurring pigment providing the reddish orange color to annatto. Bixin is soluble in fats and alcohols but insoluble in water, and is chemically unstable when isolated, converting via isomerization into the double bond isomer, trans-bixin (β-bixin), having the structure:

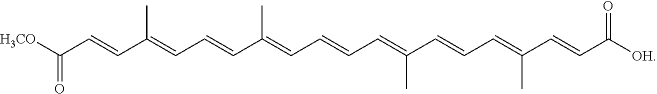 [SMILES: COC(=O)/C=C/C(C)=C/C=C/C(C)=C/C=C/C=C(C)/C=C/C=C(C)/C=C/C(=O)O]

In some embodiments, the organic acid is (2E,4E,6E,8E,10E,12E,14E,16E,18E)-4,8,13,17-tetramethylicosa-2,4,6,8,10,12,14,16,18-nonaenedioic acid (norbixin), a water-soluble hydrolysis product of bixin having the structure:

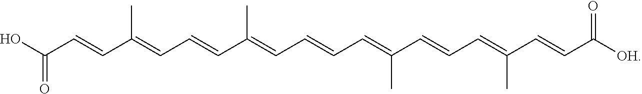 [SMILES: CC(/C=C/C=C(C)/C=C/C(=O)O)=C\C=C\C=C(C)\C=C\C=C(C)\C=C\C(=O)O]

In some embodiments, more than one organic acid may be present. For example, the composition may comprise two, or three, or four, or more organic acids. Accordingly, reference herein to “an organic acid” contemplates mixtures of two or more organic acids. The relative amounts of the multiple organic acids may vary. For example, a composition may comprise equal amounts of two, or three, or more organic acids, or may comprise different relative amounts. In this manner, it is possible to include certain organic acids (e.g., citric acid or myristic acid) which have a log P value outside the desired range, when combined with other organic acids to provide the desired average log P range for the combination. In some embodiments, it may be desirable to include organic acids in the composition which have log P values outside the desired range for purposes such as, but not limited to, providing desirable organoleptic properties, stability, as flavor components, and the like. Further, certain lipophilic organic acids have undesirable flavor and or aroma characteristics which would preclude their presence as the sole organic acid (e.g., in equimolar or greater quantities relative to nicotine). Without wishing to be bound by theory, it is believed that a combination of different organic acids may provide the desired ion pairing while the concentration of any single organic acid in the composition remains below the threshold which would be found objectionable from a sensory perspective.

In some embodiments, the composition comprises an organic acid which is a monoester of a dicarboxylic acid or is a carotenoid derivative having one or more carboxylic acids as described herein above, and further comprises an additional organic acid or salt thereof. In some embodiments, the additional organic acid is benzoic acid, an alkali metal salt thereof, or a combination thereof.

In some embodiments, the composition comprises an alkali metal salt of an organic acid. For example, at least a portion of the organic acid may be present in the composition in the form of an alkali metal salt. Suitable alkali metal salts include lithium, sodium, and potassium. In some embodiments, the alkali metal is sodium or potassium. In some embodiments, the alkali metal is sodium. In some embodiments, the composition comprises an organic acid and a sodium salt of the organic acid.

In some embodiments, the weight ratio of the organic acid to the sodium salt (or other alkali metal) of the organic acid is from about 0.1 to about 10, such as from about 0.1, about 0.25, about 0.3, about 0.5, about 0.75, or about 1, to about 2, about 5, or about 10. For example, in some embodiments, both an organic acid and the sodium salt thereof are added to the other components of the composition, wherein the organic acid is added in excess of the sodium salt, in equimolar quantities with the sodium salt, or as a fraction of the sodium salt. One of skill in the art will recognize that the relative amounts will be determined by the desired pH of the composition, as well as the desired ionic strength. For example, the organic acid may be added in a quantity to provide a desired pH level of the composition, while the alkali metal (e.g., sodium) salt is added in a quantity to provide the desired extent of ion pairing. As one of skill in the art will understand, the quantity of organic acid (i.e., the protonated form) present in the composition, relative to the alkali metal salt or conjugate base form present in the composition, will vary according to the pH of the composition and the pKa of the organic acid, as well as according to the actual relative quantities initially added to the composition.

The amount of organic acid or alkali metal salt thereof present in the composition, relative to the basic amine (e.g., nicotine), may vary. Generally, as the concentration of the organic acid (or the conjugate base thereof) increases, the percent of basic amine (e.g., nicotine) that is ion paired with the organic acid increases. This typically increases the partitioning of the basic amine (e.g., nicotine), in the form of an ion pair, into octanol versus water as measured by the log P (the log₁₀ of the partitioning coefficient). In some embodiments, the composition comprises from about 0.05, about 0.1, about 1, about 1.5, about 2, or about 5, to about 10, about 15, or about 20 molar equivalents of the organic acid, the alkali metal salt thereof, or the combination thereof, relative to the basic amine (e.g., nicotine), calculated as the free base of the basic amine.

In some embodiments, the composition comprises from about 2 to about 10, or from about 2 to about 5 molar equivalents of the organic acid, the alkali metal salt thereof, or the combination thereof, relative to the basic amine (e.g., nicotine), on a free-base basis. In some embodiments, the organic acid, the alkali metal salt thereof, or the combination thereof, is present in a molar ratio with basic amine (e.g., nicotine) from about 2, about 3, about 4, or about 5, to about 6, about 7, about 8, about 9, or about 10. In embodiments wherein more than one organic acid, alkali metal salt thereof, or both, are present, it is to be understood that such molar ratios reflect the totality of the organic acids present.

In some embodiments the organic acid inclusion is sufficient to provide a composition pH of from about 4.0 to about 9.0, such as from about 4.5 to about 7.0, or from about 5.5 to about 7.0, from about 4.0 to about 5.5, or from about 7.0 to about 9.0. In some embodiments, the organic acid inclusion is sufficient to provide a composition pH of from about 4.5 to about 6.5, for example, from about 4.5, about 5.0, or about 5.5, to about 6.0, or about 6.5. In some embodiments, the organic acid is provided in a quantity sufficient to provide a pH of the composition of from about 5.5 to about 6.5, for example, from about 5.5, about 5.6, about 5.7, about 5.8, about 5.9, or about 6.0, to about 6.1, about 6.2, about 6.3, about 6.4, or about 6.5. In some embodiments, a mineral acid (e.g., hydrochloric acid, sulfuric acid, phosphoric acid, or the like) is added to adjust the pH of the composition to the desired value.

In some embodiments, the organic acid is added as the free acid, either neat (i.e., native solid or liquid form) or as a solution in, e.g., water, to the other composition components. In some embodiments, the alkali metal salt of the organic acid is added, either neat or as a solution in, e.g., water, to the other composition components. In some embodiments, the organic acid and the basic amine (e.g., nicotine) are combined to form a salt, either before addition to the composition, or the salt is formed within and is present in the composition as such. In some embodiments, the organic acid and basic amine (e.g., nicotine) are present as individual components in the composition, and form an ion pair upon contact with moisture (e.g., saliva in the mouth of the consumer).

In some embodiments, the organic acid is added as the free acid, either neat (i.e., native solid or liquid form) or as a solution in, e.g., water, to the other composition components. In some embodiments, the alkali metal salt of the organic acid is added, either neat or as a solution in, e.g., water, to the other composition components. In some embodiments, the organic acid and a basic amine-containing active ingredient (e.g., nicotine) are combined to form a salt, either before addition to the composition, or the salt is formed within and is present in the composition as such.

### Flavoring Agent

In some embodiments, the composition as described herein comprises a flavoring agent. As used herein, a “flavoring agent” or “flavorant” is any flavorful or aromatic substance capable of altering the sensory characteristics associated with the oral product. Examples of sensory characteristics that can be modified by the flavoring agent include taste, mouthfeel, moistness, and/or fragrance/aroma. For avoidance of doubt, such flavoring agents are different and distinct from the modulators (e.g., sensates) disclosed herein. Flavoring agents may be natural or synthetic, and the character of the flavors imparted thereby may be described, without limitation, as fresh, sweet, herbal, confectionary, floral, fruity, or spicy.

Flavoring agents may be imitation, synthetic, or natural ingredients or blends thereof. Flavoring agents may include naturally occurring flavor materials, botanicals, extracts of botanicals, synthetically obtained materials, or combinations thereof (e.g., tobacco, cannabis, licorice (liquorice), hydrangea, Japanese white bark magnolia leaf, chamomile, fenugreek, maple, matcha, Japanese mint, aniseed (anise), turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, piment, ginger, coriander, coffee, hemp, a mint oil from any species of the genus Mentha, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene), and other additives such as charcoal, chlorophyll, minerals, botanicals, or breath freshening agents.

Flavoring agents may be in any suitable form, for example, liquid such as an oil, solid such as a powder, or gas. In some instances, the flavoring agent may be provided in a spray-dried form or a liquid form. In some embodiments, a liquid flavorant is disposed (i.e., adsorbed or absorbed in or on) a porous particulate carrier, for example microcrystalline cellulose, which is then combined with the other composition ingredients.

The amount of flavoring agent utilized in the composition can vary, but is typically up to about 10% by weight, and some embodiments are characterized by a flavoring agent content of at least about 0.1% by weight, such as about 0.5 to about 10%, about 1 to about 5%, or about 2 to about 4% weight, based on the total weight of the composition.

### Taste Modifier

In order to improve the organoleptic properties of a composition as disclosed herein, the composition may include one or more taste modifying agents (“taste modifiers”) which may serve to mask, alter, block, or improve e.g., the flavor of a composition as described herein. In some embodiments, the taste modifier modifies one or more of bitter, sweet, salty, or sour tastes. In some embodiments, the composition comprises an active ingredient having a bitter taste, and a taste modifier which masks or blocks the perception of the bitter taste. Suitable taste modifiers include, but are not limited to, gamma-amino butyric acid (GABA), adenosine monophosphate (AMP), lactisole, or a combination thereof.

When present, a representative amount of taste modifier is about 0.01% by weight or more, about 0.1% by weight or more, or about 1.0% by weight or more, but will typically make up less than about 10% by weight of the total weight of the composition, (e.g., from about 0.01%, about 0.05%, about 0.1%, or about 0.5%, to about 1%, about 5%, or about 10% by weight of the total weight of the composition).

### Salt

In some embodiments, the composition may further comprise a salt (e.g., alkali metal salts), typically employed in an amount sufficient to provide desired sensory attributes to the composition. Non-limiting examples of suitable salts include sodium chloride, potassium chloride, ammonium chloride, flour salt, and the like.

When present, a representative amount of salt is about 0.5 percent by weight or more, about 1.0 percent by weight or more, or at about 1.5 percent by weight or more, but will typically make up about 10 percent or less of the total weight of the composition, or about 7.5 percent or less or about 5 percent or less (e.g., about 0.5 to about 5 percent by weight).

### Sweetener

In order to improve the sensory properties of the composition according to the disclosure, one or more sweeteners may be added. The sweeteners can be any sweetener or combination of sweeteners, in natural or artificial form, or as a combination of natural and artificial sweeteners. Examples of natural sweeteners include fructose, sucrose, glucose, maltose, mannose, galactose, lactose, stevia, honey, and the like. Examples of artificial sweeteners include sucralose, isomaltulose, maltodextrin, saccharin, aspartame, acesulfame K, neotame, and the like. In some embodiments, the sweetener comprises one or more sugar alcohols. Sugar alcohols are polyols derived from monosaccharides or disaccharides that have a partially or fully hydrogenated form. Sugar alcohols have, for example, about 4 to about 20 carbon atoms and include erythritol, arabitol, ribitol, isomalt, maltitol, dulcitol, iditol, mannitol, xylitol, lactitol, sorbitol, and combinations thereof (e.g., hydrogenated starch hydrolysates). In some embodiments, the sweetener is sucralose, acesulfame K, or a combination thereof.

When present, a sweetener or combination of sweeteners may make up from about 0.01 to about 20% or more of the of the composition by weight, for example, from about 0.01 to about 0.1, from about 0.1 to about 1%, from about 1 to about 5%, from about 5 to about 10%, or from about 10 to about 20% by weight, based on the total weight of the composition. In some embodiments, a combination of sweeteners is present at a concentration of from about 0.01% to about 0.1% by weight of the composition, such as about 0.01, about 0.02, about 0.03, about 0.04, about 0.05, about 0.06, about 0.07, about 0.08, about 0.09, or about 0.1% by weight of the composition. In some embodiments, a combination of sweeteners is present at a concentration of from about 0.1% to about 0.5% by weight of the composition, such as about 0.1, about 0.2, about 0.3, about 0.4, or about 0.5% by weight of the composition. In some embodiments, a combination of sweeteners is present at a concentration of from about 1% to about 3% by weight of the composition.

### pH Adjusting Agent

The mixture within the pouch may optionally comprise one or more pH adjusters/buffering agents. Examples of pH adjusters and buffering agents that can be used include, but are not limited to, metal hydroxides (e.g., alkali metal hydroxides such as sodium hydroxide and potassium hydroxide), and other alkali metal buffers such as metal carbonates (e.g., potassium carbonate or sodium carbonate), or metal bicarbonates such as sodium bicarbonate, and the like. Where present, the buffering agent is typically present in an amount less than about 5 percent based on the weight of the film, for example, from about 0.5% to about 5%, such as, e.g., from about 0.75% to about 4%, from about 0.75% to about 3%, or from about 1% to about 2% by weight, based on the total weight of the mixture. Non-limiting examples of suitable buffers include alkali metal acetates, glycinates, phosphates, glycerophosphates, citrates, carbonates, hydrogen carbonates, borates, or mixtures thereof.

### Tobacco Material

In some embodiments, the composition can comprise a tobacco material. The tobacco material can vary in species, type, and form. Generally, the tobacco material is obtained from for a harvested plant of the Nicotiana species. Example Nicotiana species include N. tabacum, N. rustica, N. alata, N. arentsii, N. excelsior, N. forgetiana, N. glauca, N. glutinosa, N. gossei, N. kawakamii, N. knightiana, N. langsdorffi, N. otophora, N. setchelli, N. sylvestris, N. tomentosa, N. tomentosiformis, N. undulata, N. x sanderae, N. africana, N. amplexicaulis, N. benavidesii, N. bonariensis, N. debneyi, N. longiflora, N. maritina, N. megalosiphon, N. occidentalis, N. paniculata, N. plumbaginifolia, N. raimondii, N. rosulata, N. simulans, N. stocktonii, N. suaveolens, N. umbratica, N. velutina, N. wigandioides, N. acaulis, N. acuminata, N. attenuata, N. benthamiana, N. cavicola, N. clevelandii, N. cordifolia, N. corymbosa, N. fragrans, N. goodspeedii, N. linearis, N. miersii, N. nudicaulis, N. obtusifolia, N. occidentalis subsp. Hersperis, N. pauciflora, N. petunioides, N. quadrivalvis, N. repanda, N. rotundifolia, N. solanifolia, and N. spegazzinii. Various representative other types of plants from the Nicotiana species are set forth in Goodspeed, The Genus Nicotiana, (Chonica Botanica) (1954); U.S. Pat. No. 4,660,577 to Sensabaugh, Jr. et al.; U.S. Pat. No. 5,387,416 to White et al., U.S. Pat. No. 7,025,066 to Lawson et al.; U.S. Pat. No. 7,798,153 to Lawrence, Jr. and U.S. Pat. No. 8,186,360 to Marshall et al.; each of which is incorporated herein by reference. Descriptions of various types of tobaccos, growing practices and harvesting practices are set forth in Tobacco Production, Chemistry and Technology, Davis et al. (Eds.) (1999), which is incorporated herein by reference.

Nicotiana species from which suitable tobacco materials can be obtained can be derived using genetic-modification or crossbreeding techniques (e.g., tobacco plants can be genetically engineered or crossbred to increase or decrease production of components, characteristics or attributes). See, for example, the types of genetic modifications of plants set forth in U.S. Pat. No. 5,539,093 to Fitzmaurice et al.; U.S. Pat. No. 5,668,295 to Wahab et al.; U.S. Pat. No. 5,705,624 to Fitzmaurice et al.; U.S. Pat. No. 5,844,119 to Weigl; U.S. Pat. No. 6,730,832 to Dominguez et al.; U.S. Pat. No. 7,173,170 to Liu et al.; U.S. Pat. No. 7,208,659 to Colliver et al. and U.S. Pat. No. 7,230,160 to Benning et al.; US Patent Appl. Pub. No. 2006/0236434 to Conkling et al.; and PCT WO2008/103935 to Nielsen et al. See, also, the types of tobaccos that are set forth in U.S. Pat. No. 4,660,577 to Sensabaugh, Jr. et al.; U.S. Pat. No. 5,387,416 to White et al.; and U.S. Pat. No. 6,730,832 to Dominguez et al., each of which is incorporated herein by reference.

The Nicotiana species can, in some embodiments, be selected for the content of various compounds that are present therein. For example, plants can be selected on the basis that those plants produce relatively high quantities of one or more of the compounds desired to be isolated therefrom. In some embodiments, plants of the Nicotiana species (e.g., Galpao commun tobacco) are specifically grown for their abundance of leaf surface compounds. Tobacco plants can be grown in greenhouses, growth chambers, or outdoors in fields, or grown hydroponically.

Various parts or portions of the plant of the Nicotiana species can be included within a composition disclosed herein. For example, virtually all of the plant (e.g., the whole plant) can be harvested, and employed as such. Alternatively, various parts or pieces of the plant can be harvested or separated for further use after harvest. For example, the flower, leaves, stem, stalk, roots, seeds, and various combinations thereof, can be isolated for further use or treatment. In some embodiments, the tobacco material comprises tobacco leaf (lamina). The composition can include processed tobacco parts or pieces, cured and aged tobacco in essentially natural lamina and/or stem form. In some embodiments, the tobacco material comprises solid tobacco material selected from the group consisting of lamina and stems. The tobacco that is used for the composition most preferably includes tobacco lamina, or a tobacco lamina and stem mixture (of which at least a portion is smoke-treated). Portions of the tobacco may have processed forms, such as processed tobacco stems (e.g., cut-rolled stems, cut-rolled-expanded stems or cut-puffed stems), or volume expanded tobacco (e.g., puffed tobacco, such as dry ice expanded tobacco (DIET)). See, for example, the tobacco expansion processes set forth in U.S. Pat. No. 4,340,073 to de la Burde et al.; U.S. Pat. No. 5,259,403 to Guy et al.; and U.S. Pat. No. 5,908,032 to Poindexter, et al.; and U.S. Pat. No. 7,556,047 to Poindexter, et al., all of which are incorporated by reference. In addition, the composition may incorporate tobacco that has been fermented. See, also, the types of tobacco processing techniques set forth in PCT WO2005/063060 to Atchley et al., which is incorporated herein by reference.

The tobacco material is typically used in a form that can be described as particulate, for example, shredded, ground, granulated, pulp, or powder form. In some embodiments, the tobacco material is employed in the form of parts or pieces that have an average particle size between 1.4 millimeters and 250 microns. In some instances, the tobacco particles may be sized to pass through a screen mesh to obtain the particle size range required. If desired, air classification equipment may be used to ensure that small sized tobacco particles of the desired sizes, or range of sizes, may be collected. If desired, differently sized pieces of granulated tobacco may be mixed together.

The manner by which the tobacco material is provided in a finely divided or powder type of form may vary. Preferably, plant parts or pieces are milled, comminuted, ground or pulverized into a particulate form using equipment and techniques for grinding, milling, or the like. The plant, or parts thereof, can be subjected to external forces or pressure (e.g., by being pressed or subjected to roll treatment). When carrying out such processing conditions, the plant or portion thereof can have a moisture content that approximates its natural moisture content (e.g., its moisture content immediately upon harvest), a moisture content achieved by adding moisture to the plant or portion thereof, or a moisture content that results from the drying of the plant or portion thereof. For example, powdered, pulverized, ground, pulped or milled pieces of plants or portions thereof can have moisture contents of less than about 25 weight percent, often less than about 20 weight percent, and frequently less than about 15 weight percent. Most preferably, the plant material is relatively dry in form during grinding or milling, using equipment such as hammer mills, cutter heads, air control mills, or the like. For example, tobacco parts or pieces may be ground or milled when the moisture content thereof is less than about 15 weight percent or less than about 5 weight percent.

It is typical for a harvested plant of the Nicotiana species to be subjected to a curing process. The tobacco materials incorporated within the composition as disclosed herein are generally those that have been appropriately cured and/or aged. Descriptions of various types of curing processes for various types of tobaccos are set forth in Tobacco Production, Chemistry and Technology, Davis et al. (Eds.) (1999). Examples of techniques and conditions for curing flue-cured tobacco are set forth in Nestor et al., Beitrage Tabakforsch. Int., 20, 467-475 (2003) and U.S. Pat. No. 6,895,974 to Peele, which are incorporated herein by reference. Representative techniques and conditions for air curing tobacco are set forth in U.S. Pat. No. 7,650,892 to Groves et al.; Roton et al., Beitrage Tabakforsch. Int., 21, 305-320 (2005) and Staaf et al., Beitrage Tabakforsch. Int., 21, 321-330 (2005), which are incorporated herein by reference. Certain types of tobaccos can be subjected to alternative types of curing processes, such as fire curing or sun curing.

In some embodiments, tobacco materials that can be employed include flue-cured or Virginia (e.g., K326), burley, sun-cured (e.g., Indian Kurnool and Oriental tobaccos, including Katerini, Prelip, Komotini, Xanthi and Yambol tobaccos), Maryland, dark, dark-fired, dark air cured (e.g., Madole, Passanda, Cubano, Jatin and Bezuki tobaccos), light air cured (e.g., North Wisconsin and Galpao tobaccos), Indian air cured, Red Russian and Rustica tobaccos, as well as various other rare or specialty tobaccos and various blends of any of the foregoing tobaccos.

The tobacco material may also have a so-called “blended” form. For example, the tobacco material may include a mixture of parts or pieces of flue-cured, burley (e.g., Malawi burley tobacco) and Oriental tobaccos (e.g., as tobacco composed of, or derived from, tobacco lamina, or a mixture of tobacco lamina and tobacco stem). For example, a representative blend may incorporate about 30 to about 70 parts burley tobacco (e.g., lamina, or lamina and stem), and about 30 to about 70 parts flue cured tobacco (e.g., stem, lamina, or lamina and stem) on a dry weight basis. Other example tobacco blends incorporate about 75 parts flue-cured tobacco, about 15 parts burley tobacco, and about 10 parts Oriental tobacco; or about 65 parts flue-cured tobacco, about 25 parts burley tobacco, and about 10 parts Oriental tobacco; or about 65 parts flue-cured tobacco, about 10 parts burley tobacco, and about 25 parts Oriental tobacco; on a dry weight basis. Other example tobacco blends incorporate about 20 to about 30 parts Oriental tobacco and about 70 to about 80 parts flue-cured tobacco on a dry weight basis.

Tobacco materials used in the present disclosure can be subjected to, for example, fermentation, bleaching, and the like. If desired, the tobacco materials can be, for example, irradiated, pasteurized, or otherwise subjected to controlled heat treatment. Such treatment processes are detailed, for example, in U.S. Pat. No. 8,061,362 to Mua et al., which is incorporated herein by reference. In some embodiments, tobacco materials can be treated with water and an additive capable of inhibiting reaction of asparagine to form acrylamide upon heating of the tobacco material (e.g., an additive selected from the group consisting of lysine, glycine, histidine, alanine, methionine, cysteine, glutamic acid, aspartic acid, proline, phenylalanine, valine, arginine, compositions incorporating di- and trivalent cations, asparaginase, certain non-reducing saccharides, certain reducing agents, phenolic compounds, certain compounds having at least one free thiol group or functionality, oxidizing agents, oxidation catalysts, natural plant extracts (e.g., rosemary extract), and combinations thereof. See, for example, the types of treatment processes described in U.S. Pat. Nos. 8,434,496, 8,944,072, and 8,991,403 to Chen et al., which are all incorporated herein by reference. In some embodiments, this type of treatment is useful where the original tobacco material is subjected to heat in the processes previously described.

In some embodiments, the type of tobacco material is selected such that it is initially visually lighter in color than other tobacco materials to some degree (e.g., whitened or bleached). Tobacco pulp can be whitened in some embodiments according to any means known in the art. For example, bleached tobacco material produced by various whitening methods using various bleaching or oxidizing agents and oxidation catalysts can be used. Example oxidizing agents include peroxides (e.g., hydrogen peroxide), chlorite salts, chlorate salts, perchlorate salts, hypochlorite salts, ozone, ammonia, potassium permanganate, and combinations thereof. Example oxidation catalysts are titanium dioxide, manganese dioxide, and combinations thereof. Processes for treating tobacco with bleaching agents are discussed, for example, in U.S. Pat. Nos. 787,611 to Daniels, Jr.; 1,086,306 to Oelenheinz; U.S. Pat. No. 1,437,095 to Delling; U.S. Pat. No. 1,757,477 to Rosenhoch; U.S. Pat. No. 2,122,421 to Hawkinson; 2, 148,147 to Baier; 2, 170, 107 to Baier; U.S. Pat. No. 2,274,649 to Baier; U.S. Pat. No. 2,770,239 to Prats et al.; U.S. Pat. No. 3,612,065 to Rosen; U.S. Pat. No. 3,851,653 to Rosen; U.S. Pat. No. 3,889,689 to Rosen; U.S. Pat. No. 3,943,940 to Minami; U.S. Pat. No. 3,943,945 to Rosen; U.S. Pat. No. 4,143,666 to Rainer; U.S. Pat. No. 4,194,514 to Campbell; U.S. Pat. Nos. 4,366,823, 4,366,824, and 4,388,933 to Rainer et al.; U.S. Pat. No. 4,641,667 to Schmekel et al.; U.S. Pat. No. 5,713,376 to Berger; U.S. Pat. No. 9,339,058 to Byrd Jr. et al.; U.S. Pat. Nos. 9,420,825 and 10,772,349 to Beeson et al.; and 9,950,858 to Byrd Jr. et al.; as well as in US Pat. App. Pub. Nos. 2012/0067361 to Bjorkholm et al.; 2016/0073686 to Crooks; 2017/0020183 to Bjorkholm; and 2017/0112183 to Bjorkholm, and in PCT Publ. Appl. Nos. WO1996/031255 to Giolvas; WO2020128971 and WO2021048769 to McClanahan et al; WO2013122948A1 to Beeson et al.; WO2018/083114 to Bjorkholm; and WO2021048768 and WO2021048770A1 to Zawadzki et al., all of which are incorporated herein by reference.

In some embodiments, the whitened tobacco material can have an ISO brightness of at least about 50%, at least about 60%, at least about 65%, at least about 70%, at least about 75%, or at least about 80%. In some embodiments, the whitened tobacco material can have an ISO brightness in the range of about 50% to about 90%, about 55% to about 75%, or about 60% to about 70%. ISO brightness can be measured according to ISO 3688:1999 or ISO 2470-1:2016.

In some embodiments, the whitened tobacco material can be characterized as lightened in color (e.g., “whitened”) in comparison to an untreated tobacco material. White colors are often defined with reference to the International Commission on Illumination's (CIE's) chromaticity diagram. The whitened tobacco material can, in some embodiments, be characterized as closer on the chromaticity diagram to pure white than an untreated tobacco material.

The tobacco material may be processed to remove at least a portion of the nicotine present. Suitable methods of extracting nicotine from tobacco material are known in the art. In some embodiments, the tobacco material is substantially free of nicotine. By “substantially free” is meant that only trace amounts are present in the tobacco material. For example, in some embodiments, the tobacco material can be characterized as having less than 0.001% by weight of nicotine, or less than 0.0001%, or even 0% by weight of nicotine, calculated as the free base, and based on the total weight of the tobacco material.

The quantity of tobacco material present may vary, and is generally less than about 65% by weight of the composition, based on the total weight of the composition. For example, a tobacco material may be present in a quantity from about 0%, about 0.1%, about 0.5%, about 1%, about 5%, about 10%, about 15%, about 20%, about 25%, about 30%, or about 35%, to about 40%, about 45%, about 50%, about 55%, about 60%, or about 65% by weight of the composition, based on the total dry weight of the composition.

In some embodiments, the composition of the disclosure can be characterized as completely free or substantially free of any tobacco material (e.g., any embodiment as disclosed herein may be completely or substantially free of any tobacco material). By “substantially free” is meant that no tobacco material has been intentionally added, beyond trace amounts that may be naturally present in e.g., botanical or herbal material. For example, some embodiments can be characterized as having less than 0.5% by weight tobacco material, less than 0.1% by weight tobacco material, less than 0.01% by weight tobacco material, or less than 0.001%, or even 0% by weight tobacco material, based on the total wet weight of the composition.

### Compositional Binders

In some embodiments, the composition may comprise a binder or combination of binders to provide the desired physical attributes and physical integrity to the composition, such as a thickening or gelling agent. Typical binders can be organic or inorganic, or a combination thereof. Representative binders include povidone, sodium alginate, starch-based binders, pectin, carrageenan, pullulan, zein, and the like, and combinations thereof. A binder may be employed in amounts sufficient to provide the desired physical attributes and physical integrity to the composition. The amount of binder utilized in the composition can vary, but is typically up to about 30 weight percent, and some embodiments are characterized by a binder content of at least about 0.1% by weight, such as about 1 to about 30% by weight, or about 5 to about 10% by weight, based on the total weight of the composition.

Other suitable binders include a gum, for example, a natural gum. As used herein, a natural gum refers to polysaccharide materials of natural origin that have binding properties, and which are also useful as a thickening or gelling agents. Representative natural gums derived from plants, which are typically water soluble to some degree, include xanthan gum, guar gum, gum arabic, ghatti gum, gum tragacanth, karaya gum, locust bean gum, gellan gum, and combinations thereof. When present, natural gum binder materials are typically present in an amount of up to about 5% by weight, for example, from about 0.1, about 0.2, about 0.3, about 0.4, about 0.5, about 0.6, about 0.7, about 0.8, about 0.9, or about 1%, to about 2, about 3, about 4, or about 5% by weight, based on the total weight of the composition.

### Humectants

In some embodiments, one or more humectants may be employed in the composition. Examples of humectants include, but are not limited to, polyols such as glycerin, propylene glycol, and the like.

Where included, the humectant is typically provided in an amount sufficient to provide desired moisture attributes to the composition. Further, in some instances, the humectant may impart desirable flow characteristics to the composition for depositing in a mold.

When present, a humectant will typically make up about 5% or less of the weight of the composition (e.g., from about 0.5 to about 5% by weight). When present, a representative amount of humectant is about 0.1% to about 1% by weight, or about 1% to about 5% by weight, based on the total weight of the composition.

Colorants A colorant may be employed in amounts sufficient to provide the desired physical attributes to the composition. Natural or synthetic colorants, such as natural or synthetic dyes, food-grade colorants and pharmaceutical-grade colorants may be used. Examples of colorants include various dyes and pigments, such as caramel coloring and titanium dioxide. Natural colorants such as curcumin, beet juice extract, spirulina; also a variety of synthetic pigments may also be used. The amount of colorant utilized in the composition can vary, but when present is typically up to about 3% by weight, such as from about 0.1%, about 0.5%, or about 1%, to about 3% by weight, based on the total weight of the composition.

### Oral Care Additives

In some embodiments, the composition comprises an oral care ingredient (or mixture of such ingredients). Oral care ingredients provide the ability to inhibit tooth decay or loss, inhibit gum disease, relieve mouth pain, whiten teeth, or otherwise inhibit tooth staining, elicit salivary stimulation, inhibit breath malodor, freshen breath, or the like. For example, effective amounts of ingredients such as thyme oil, eucalyptus oil and zinc (e.g., such as the ingredients of formulations commercially available as ZYTEX® from Discus Dental) can be incorporated into the composition. Other examples of ingredients that can be incorporated in desired effective amounts within the present composition can include those that are incorporated within the types of oral care compositions set forth in Takahashi et al., Oral Microbiology and Immunology, 19 (1), 61-64 (2004); U.S. Pat. No. 6,083,527 to Thistle; and US Pat. Appl. Pub. Nos. 2006/0210488 to Jakubowski and 2006/02228308 to Cummins et al. Other exemplary ingredients of tobacco containing-formulation include those contained in formulations marketed as MALTISORB® by Roquette and DENTIZYME® by NatraRx. When present, a representative amount of oral care additive is at least about 1%, often at least about 3%, and frequently at least about 5% of the total dry weight of the composition. The amount of oral care additive within the composition will not typically exceed about 30%, often will not exceed about 25%, and frequently will not exceed about 20%, of the total dry weight of the composition.

### Processing Aids

If necessary for downstream processing of the composition, such as granulation, mixing, or molding, a flow aid can also be added to the composition in order to enhance flowability of the composition. In some embodiments, the composition (e.g., melt and chew forms) may be surface treated with anti-stick agents, such as oils, silicones, and the like. Exemplary flow aids include microcrystalline cellulose, silica, polyethylene glycol, stearic acid, calcium stearate, magnesium stearate, zinc stearate, sodium stearyl fumarate, canauba wax, and combinations thereof. In some embodiments, the flow aid is sodium stearyl fumarate.

When present, a representative amount of flow aid may make up at least about 0.5 percent or at least about 1 percent, of the total dry weight of the composition. Preferably, the amount of flow aid within the composition will not exceed about 5 percent, and frequently will not exceed about 3 percent, of the total dry weight of the composition.

### Other Additives

Other additives can be included in the disclosed composition. For example, the composition can be processed, blended, formulated, combined and/or mixed with other materials or ingredients. The additives can be artificial, or can be obtained or derived from herbal or biological sources. Examples of further types of additives include thickening or gelling agents (e.g., fish gelatin), emulsifiers, preservatives (e.g., potassium sorbate and the like), disintegration aids, or combinations thereof. See, for example, those representative components, combination of components, relative amounts of those components, and manners and methods for employing those components, set forth in U.S. Pat. No. 9,237,769 to Mua et al., U.S. Pat. No. 7,861,728 to Holton, Jr. et al., US Pat. App. Pub. No. 2010/0291245 to Gao et al., and US Pat. App. Pub. No. 2007/0062549 to Holton, Jr. et al., each of which is incorporated herein by reference.

Typical inclusion ranges for such additional additives can vary depending on the nature and function of the additive and the intended effect on the final composition, with an example range of up to about 10% by weight, based on total weight of the composition (e.g., about 0.1 to about 5% by weight).

The aforementioned additives can be employed together (e.g., as additive formulations) or separately (e.g., individual additive components can be added at different stages involved in the preparation of the final mixture). Furthermore, the aforementioned types of additives may be encapsulated as provided in the final product or composition. Example encapsulated additives are described, for example, in WO2010/132444 to Atchley, which has been previously incorporated by reference herein.

### Preparation of the Composition & Oral Product

The manner by which the various components of an oral composition for inclusion within the oral product are combined can vary. As such, the overall mixture of various components with e.g., powdered mixture components may be relatively uniform in nature. The components noted above, which may be in liquid or dry solid form, can be admixed in a pretreatment step prior to mixture with any remaining components of the mixture, or simply mixed together with all other liquid or dry ingredients. The various components of the mixture may be contacted, combined, or mixed together using any mixing technique or equipment known in the art. Any mixing method that brings the mixture ingredients into intimate contact can be used, such as a mixing apparatus featuring an impeller or other structure capable of agitation. Examples of mixing equipment include casing drums, conditioning cylinders or drums, liquid spray apparatus, conical-type blenders, ribbon blenders, mixers available as FKM130, FKM600, FKM1200, FKM2000 and FKM3000 from Littleford Day, Inc., Plough Share types of mixer cylinders, Hobart mixers, and the like. See also, for example, the types of methodologies set forth in U.S. Pat. No. 4,148,325 to Solomon et al.; U.S. Pat. No. 6,510,855 to Korte et al.; and U.S. Pat. No. 6,834,654 to Williams, each of which is incorporated herein by reference. Manners and methods for formulating mixtures will be apparent to those skilled in the art. See, for example, the types of methodologies set forth in U.S. Pat. No. 4,148,325 to Solomon et al.; U.S. Pat. No. 6,510,855 to Korte et al.; and U.S. Pat. No. 6,834,654 to Williams, U.S. Pat. No. 4,725,440 to Ridgway et al., and U.S. Pat. No. 6,077,524 to Bolder et al., each of which is incorporated herein by reference.

In some embodiments, the compositions of the disclosure are formed by first mixing any dry ingredients including any filler components, optional salts, and any solid forms of nicotine (e.g., a nicotine-polymer complex). Thereafter, liquid components of the composition are added to the dry mixture, such as by addition of an aqueous solution containing dissolved or miscible ingredients such as humectants, flavorants, and sweeteners. Thereafter, it can be advantageous in some embodiments to add an acid to reduce the pH of the composition to the desired range, such as a pH of about 4 to about 5. The amount of material contained within each product unit, for example, a pouch, may vary. In some embodiments, the weight of the composition within each pouch is at least about 50 mg, for example, from about 50 mg to about 1 gram, from about 100 to 800 about mg, or from about 200 to about 700 mg. In some smaller embodiments, the weight of the composition within each pouch may be from about 100 to about 300 mg. For a larger embodiment, the weight of the composition within each pouch may be from about 300 mg to about 700 mg. If desired, other components can be contained within each pouch. For example, at least one flavored strip, piece or sheet of flavored water dispersible or water soluble material (e.g., a breath-freshening edible film type of material) may be disposed within each pouch along with or without at least one capsule. Such strips or sheets may be folded or crumpled in order to be readily incorporated within the pouch. See, for example, the types of materials and technologies set forth in U.S. Pat. No. 6,887,307 to Scott et al. and U.S. Pat. No. 6,923,981 to Leung et al.; and The EFSA Journal (2004) 85, 1-32; which are incorporated herein by reference.

The elastic fleece material described herein can be used to form the pouched product in various manners, e.g., by providing a continuous supply of the fleece material according to the present disclosure; forming it into a continuous tubular member by sealing the lateral edges of the fleece material such that a longitudinally extending seam is formed. The seam can be formed, for example, by applying conventional heat sealing techniques to the fleece material, resulting in softening and/or melting of a heat sealable binder material that may be present in the fleece material to form a seal.

A charge of a composition adapted for oral use can be inserted into the continuous tubular member; the continuous tubular member can be subdivided at predetermined intervals so as to form a plurality of pouch member portions, wherein each pouch member portion includes a charge of the composition. Each discrete pouch portion can then be entirely sealed such that an outer water-permeable pouch comprising the fleece material provided herein is formed that encloses the composition. This second sealing step can involve applying conventional heat sealing techniques to the pouch material, resulting in softening and/or melting of a heat sealable binder material in the nonwoven web to form a seal. Sealing can alternatively (or in addition) be conducted by sonic welding. Accordingly, aspects of the present disclosure are particularly configured to provide discrete pouched products. The operations described and the order of the method steps illustrated herein are not construed as limiting thereof.

Pouching equipment suitable to produce oral products as described herein can be any type of equipment that can be used to enclose an oral composition within a fleece material to produce a pouch. Non-limiting examples of such pouching equipment (also referred to as pouchers or pouching machines) include, e.g., those manufactured by Merz Verpackungsmaschinen GmbH, Lich, Germany and G.D. SpA of Italy and those disclosed in U.S. Pat. No. 11,284,643 to Carroll, U.S. Pat. No. 10,870,503 to Garthaffner et al., and U.S. Pat. No. 8,151,802 to Boldrini, and U.S. Patent Application Publication Nos. 2010/0018539 to Brinkley et al., which are all incorporated herein by reference in their entireties. An example apparatus for manufacturing an oral pouch product is illustrated in FIGS. 1-5 of U.S. Patent Application Publication No. 2012/0055493 to Novak, III et al.; however, this apparatus is used in a generic and descriptive sense only and not for purposes of limitation. It should also be appreciated that the following manufacturing process and related equipment is not limited to the process order described. The pouched products can further include product identifying information printed or dyed on the outer water-permeable pouch or imprinted (e.g., embossed, debossed, or otherwise pressed) on the outer water-permeable pouch, such as described in U.S. Patent Application Publication No. 2014/0255452 to Reddick et al., which is incorporated by reference herein.

Many modifications and other embodiments of the disclosure will come to mind to one skilled in the art to which this disclosure pertains having the benefit of the teachings presented in the foregoing description. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A pouched product, comprising:
an outer water-permeable pouch defining a cavity and an oral composition comprising at least one water-soluble component within the cavity,
wherein the outer water-permeable pouch comprises a fleece material comprising a plurality of fibers, and
wherein at least a portion of the plurality of fibers comprise elastic or elastomeric fibers, the elastic or elastomeric fibers comprising one or more elastic or elastomeric materials.

2. The pouched product of claim 1, wherein the outer water-permeable pouch comprises a single layer comprising the plurality of fibers.

3. The pouched product of claim 1, wherein the outer water-permeable pouch comprises two or more layers, wherein at least one of the two or more layers comprises the elastic or elastomeric fibers.

4. The pouched product of claim 1, wherein the elastic or elastomeric materials comprise one or more thermoplastic elastomers.

5. The pouched product of claim 4, wherein the one or more thermoplastic elastomers are selected from the group consisting of styrenic elastomers, polyester elastomers, polyether elastomers, polysulfide elastomers, polyurethane elastomers, polyamide elastomers, polyolefin elastomers, thermoplastic vulcanizates, and copolymers, blends, and derivatives thereof, optionally, wherein the one or more thermoplastic elastomers comprise a polyurethane elastomer.

6. The pouched product of claim 4, wherein the thermoplastic elastomers are selected from polyisoprenes, butadiene rubber, styrene-butadiene rubber, poly(styrene-b-butadiene-b-styrene) (SBS), poly(styrene-b-ethene-co-butane-b-styrene (SEBS), poly(styrene-b-isoprene-b-styrene), ethylene propylene diene monomer rubber (EPDM rubber), EPDM rubber/polypropylene (EPDM/PP), polychloroprene, acrylonitrile-butadiene rubber, hydrogenated nitrile rubber, butyl rubber, ethylene-propylene rubber (EPM), silicone rubber, chlorosulfonated polyethylene, polyacrylate rubber, fluorocarbon rubber, chlorinated polyethylene rubber, epichlorohydrin rubber, ethylene-vinyl acetate copolymer, styrene-isoprene block copolymer, urethane rubber, and copolymers, blends, and derivatives thereof.

7. The pouched product of claim 1, wherein the elastic or elastomeric materials comprise one or more gums.

8. The pouched product of claim 7, wherein the one or more gums are selected from the group consisting of xanthan gum, guar gum, gum arabic, ghatti gum, gum tragacanth, karaya gum, locust bean gum, gellan gum, and combinations thereof, optionally,
wherein the one or more gums comprise guar gum.

9. The pouched product of claim 1, wherein the elastic or elastomeric fibers are in the form of fibers consisting essentially of the elastic or elastomeric material.

10. The pouched product of claim 1, wherein the elastic or elastomeric fibers comprise a blend of the one or more elastic or elastomeric materials and one or more additional materials.

11. The pouched product of claim 1, wherein the elastic or elastomeric fibers are in the form of multicomponent fibers comprising: a first component comprising the one or more elastic or elastomeric materials and a second component comprising one or more additional materials, optionally,
wherein the elastic or elastomeric fibers are fibers with a cross-section having a sheath/core structure, an islands-in-the-sea structure, a side-by-side structure, a segmented pie structure, a hollow segmented pie structure, a segmented cross structure, a segmented ribbon structure, or a tipped multilobal structure.

12. The pouched product of claim 10, wherein the one or more additional materials are selected from the group consisting of polyesters, polyamides, polyolefins, polyacrylates, thermoplastic liquid crystalline polymers, and copolymers, blends, and derivatives thereof, and in particular,
wherein the one or more additional materials are selected from the group consisting of polybutylene succinate (PBS), poly (butylene succinate)-co-(butylene carbonate) (PBS-co-BC), polyethylene carbonate (PEC), polyhydroxyalkanoates (PHA) such as polyhydroxybutyrate (PHB), poly (glycolic acid) (PGA), polycaprolactone (PCL), polypropylene, and copolymers, blends, and derivatives thereof.

13. The pouched product of claim 1, wherein the plurality of fibers consist essentially of the elastic or elastomeric fibers.

14. The pouched product of claim 1, wherein the plurality of fibers comprises one or more fiber types in addition to the elastic or elastomeric fibers, optionally,
wherein the one or more fiber types are fibers comprising one or more materials selected from the group consisting of wool, cotton, regenerated cellulose, cellulose acetate, cellulose triacetate, cellulose nitrate, ethyl cellulose, cellulose acetate propionate, cellulose acetate butyrate, hydroxypropyl cellulose, methyl hydroxypropyl cellulose, and protein fibers.

15. The pouched product of claim 14, wherein at least 50% by volume of the fleece material comprises the elastic or elastomeric fibers, optionally,
wherein at least 90% by volume of the fleece material comprises the elastic or elastomeric fibers.

16. The pouched product of claim 1, wherein the oral composition comprises at least one of an active agent and a flavorant in an amount of at least about 0.5% by weight of the oral composition; and a filler in an amount of at least about 30% by weight of the oral composition, optionally,
wherein the filler is selected from the group consisting of a sugar substitute, microcrystalline cellulose, and a combination thereof.

17. The pouched product of claim 15, wherein the oral composition is in particulate form.

18. The pouched product of claim 14, wherein the filler is in the form of a cellulose sponge, and wherein the at least one of an active agent and flavorant is associated with the cellulose sponge via surface absorption or by binder via chemical bond.

19. A method of preparing the pouched product of claim 1, comprising:
producing the fleece material comprising a plurality of fibers by:
drylaying the plurality of fibers and thermally or chemically bonding the plurality of fibers;
spunlacing the plurality of fibers and thermally or chemically bonding the plurality of fibers; or
spunlaying the plurality of fibers and thermally or chemically bonding the plurality of fibers; and
forming the water-permeable pouch material into the water-permeable pouch and enclosing the oral composition within the water-permeable pouch.

20. A method of preparing the pouched product of claim 1, comprising:
providing a nonwoven web comprising splittable fibers comprising the elastic or elastomeric component;
treating the nonwoven web to split the splittable fibers to give the elastic or elastomeric fibers to give a water-permeable pouch material; and
forming the water-permeable pouch material into the water-permeable pouch and enclosing the oral composition within the water-permeable pouch.
